(19) United States
(12) Patent Application Publication
(10) Pub. No.: US 2007/0132572 A1
(43) Pub. Date: Jun. 14, 2007

(54) Instrument panel image display device, instrument panel image changing method, vehicle, server, instrument panel image changing system, instrument panel image display program, computer-readable storage medium storing instrument panel image display program

(75) Inventors: Megumi Itoh, Nara-shi (JP); Toshiya Takahashi, Soraku-gun (JP); Mitsukazu Okudo, Ikoma-shi (JP); Takeshi Yamamoto, Soraku-gun (JP); Aki Miake, Nara-shi (JP); Takeshi Doi, Kashiwara-shi (JP)

Correspondence Address: SHARP KABUSHIKI KAISHA;C/O KEATING & BENNETT, LLP, 8180 GREENSBORO DRIVE, SUITE 850, MCLEAN, VA, 22102, US

(73) Assignee: SHARP KABUSHIKI KAISHA, Osaka-shi, Osaka (JP)

(21) Appl. No.: 10/598,110

(22) PCT Filed: Feb. 16, 2005
(86) PCT No.: PCT/JP05/02841

§ 371 Date: Aug. 17, 2006

(30) Foreign Application Priority Data
May 26, 2004 (JP) 2004-156696
Feb. 20, 2004 (JP) 2004-045459

(51) Int. Cl. B60Q 1/00; G06T 1/00

(52) U.S. Cl. 340/462; 345/418

(57) ABSTRACT

An instrument panel image display device displays an instrument panel image by which various information is provided to a driver. In this device, the instrument panel image includes a plurality of gauge-like images displayed at specific positions in the instrument panel image display device. Further, this device includes an image data changing section for changing image data, which generates each gauge-like image, into image data, which generates another gauge-like image. This makes it possible to display a new instrument panel image by combining various gauge-like images. That is, in this instrument panel image display device, it is possible to more freely select the instrument panel image.

### BACKGROUND OF THE INVENTION

1. Field of the Invention

The present invention relates to an instrument panel image display device, an instrument panel image changing method, a vehicle, a server, an instrument panel image changing system, an instrument panel image display program, a computer-readable storage medium storing the instrument panel image display program, whereby it is possible to change a displayed instrument panel image into another instrument panel image.

2. Description of the Related Art

Recently, instrument panels have been widely used in vehicles such as automobiles, where a liquid crystal panel or other similar display device displays an instrument panel image. In such a display, an instrument panel image of various gauge-like images, such as a speedometer image, a tachometer image, a fuel gauge image, and other similar gauge-like images, is displayed.

However, the conventional instrument panel has the problem that a driver cannot change the displayed instrument panel image.

In order to solve this problem, Japanese Unexamined Patent Publication No. 297318/1998 (Tokukaihei 10-297318, which was published on Nov. 10, 1998) discloses an instrument panel image selection device, which includes storage means for storing plural sets of instrument panel image data; selection means for selecting instrument panel image data, which corresponds to a selection operation from the plural sets of instrument panel image data, to generate a selection signal thereof; and instrument panel image data output means for outputting to the instrument panel image display means instrument panel image data selected from the plural sets of instrument panel image data, which corresponds to the selection signal.

According to Tokukaihei 10-297318, when the foregoing device is used, it is possible for the driver to select a desired instrument panel image and cause the instrument panel image display means to display the selected instrument panel image. Similar techniques are disclosed by Japanese Unexamined Patent Publication No. 297392/1998 (Tokukaihei 10-297392, which was published on Nov. 10, 1998), Japanese Unexamined Patent Publication No. 308136/1998 (Tokukaihei 10-308136, which was published on Nov. 17, 1998), Japanese Unexamined Patent Publication No. 297319/1998 (Tokukaihei 10-297319, which was published on Nov. 10, 1998), Japanese Unexamined Patent Publication No. 57730/1991 (Tokukaihei 3-57730, which was published on Mar. 13, 1991), and Japanese Unexamined Patent Publication No. 095040/2003 (Tokukai 2003-095040, which was published on Apr. 3, 2003).

However, each of the foregoing conventional techniques has the problem that an instrument panel image is not freely selected.

That is, according to the foregoing conventional techniques, the driver can simply change an entire instrument panel image to another instrument panel image. Thus, for example, when the driver wants to select a new instrument panel image obtained by combining a speedometer image of an instrument panel image with a tachometer image of another instrument panel image, such operation is not allowed. That is, the driver cannot combine desired gauges with each other to make an original instrument panel image and display the original instrument panel image.

### SUMMARY OF THE INVENTION

To overcome the problem described above, preferred embodiments of the present invention provide an instrument panel image display device which allows an instrument panel image to be more freely selected with visibility of gauges taken into consideration, an instrument panel image changing method, an instrument panel image display program, and a computer-readable storage medium storing the instrument panel image display program.

Further, a vehicle is provided that includes the foregoing instrument panel image display device and a server for providing image data, which generates a replacing gauge-like image, to the instrument panel image display device.

Moreover, an instrument panel image changing system is provided that includes the instrument panel image display device and the server.

In order to solve the foregoing problems, an instrument panel image display device is installed on an apparatus to display an instrument panel image. The instrument panel image display device includes a display arranged to display the instrument panel image including a gauge-like image, by which internal and external information of the apparatus is provided to a user, in accordance with that image data, which generates the gauge-like image, and includes an image data changing section arranged to change the image data, which generates the gauge-like image, into image data, which generates another gauge-like image.

The present device is preferably installed on an apparatus, such as a vehicle or other suitable apparatus, which includes a gauge panel. Further, the present device is provided with an instrument panel preferably including a liquid crystal display or other suitable display device, thereby displaying an instrument panel image.

Further, an instrument panel image displayed in the present device includes plural gauge-like images, such as a speedometer image and a tachometer image, each of which notifies a user about internal and external information of the apparatus having the present device. Further, each of these gauge-like images is generated by image data. That is, in the present device, the display causes the instrument panel to display each of the gauge-like images generated by the plural sets of image data, thereby displaying an entire instrument panel image including the plural gauge-like images.

In the present device, the image data changing section does not change the image data, which generates the entire instrument panel image, into other instrument panel image, but changes the image data, which generates each gauge-like image included in the instrument panel image, into image data, which generates another gauge-like image. That is, the present device is arranged so that changeable gauge-like images are combined with each other to display an instrument panel image having a new arrangement that has not been prepared in advance. Because of this, the present device makes it possible to more freely select an instrument panel image.

Further, an instrument panel image changing method according to a preferred embodiment of the present invention is a method of changing an instrument panel image displayed in an instrument panel image display device installed on an apparatus. The method includes the steps of displaying the instrument panel image including a gauge-like image, by which internal and external information of the apparatus is provided to a user, and a background image, which serves as a background of the gauge-like image, in accordance with image data that generates the gauge-like image and image data which generates the background image; and changing the image data, which generates the background image, into image data, which generates another background image.

According to this arrangement, the present method provides the same effects and advantages as the aforementioned present device.

Further, an instrument panel image display device according to another preferred embodiment of the present invention is an instrument panel image display device that is installed on an apparatus to display an instrument panel image. The instrument panel image display device includes a display arranged to display the instrument panel image including a gauge-like image, by which internal and external information is provided to a user, and a background image, which serves as a background of the gauge-like image, in accordance with image data which generates the gauge-like image and image data which generates the background image; and an image data changing section arranged to change the image data, which generates the background image, into image data, which generates other background image.

The present device is preferably installed on an apparatus, such as a vehicle, which includes a gauge panel. Further, the present device is provided, for example, with an instrument panel such as a liquid crystal panel, thereby displaying an instrument panel image.

Further, an instrument panel image displayed in the present device includes a plurality of gauge-like images, such as a speedometer image and a tachometer image, each of which notifies a user about internal and external information of the apparatus having the present device; and a background image which serves as a background of the gauge-like images. Further, each of the gauge-like image and the background image is generated by image data. That is, in the present device, the display causes an instrument panel to display the gauge-like images and the background image that are generated by plural sets of image data, thereby displaying an entire instrument panel image having the gauge-like images and the background image in the instrument panel.

In the present device, the image data changing section does not change image data, which generates the entire instrument panel image, into other instrument panel image, but changes image data, which generates a background image included in the instrument panel image, into image data, which generates another background image. That is, the present device is arranged so that a new background image and gauge-like images are combined with each other to display an instrument panel image having a new arrangement that has not been prepared in advance. Because of this, the present device makes it possible to more freely select an instrument panel image.

Further, an instrument panel image changing method according to a preferred embodiment of the present invention is a method of changing an instrument panel image displayed in an instrument panel image display device installed on an apparatus. The method includes the steps of displaying the instrument panel image including a gauge-like image, by which internal and external information of the apparatus is provided to a user, and a background image, which serves as a background of the gauge-like image, in accordance with image data which generates the gauge-like image and image data which generates the background image; and changing the image data, which generates the background image, into image data, which generates another background image.

According to this arrangement, the present method provides the same effects and advantages as the aforementioned device.

Other features, elements, steps, characteristics and advantages of the present invention will become more apparent according to preferred embodiments of the present invention with reference to the attached drawings.

### BRIEF DESCRIPTION OF DRAWINGS

FIG. 1 is a block diagram illustrating an arrangement of an instrument panel image display device according to a preferred embodiment of the present invention.

FIG. 2 illustrates gauge-like image data, background image data, and thumbnail image data that are included in an image database.

FIG. 3 illustrates an example of a type of a parameter correction table stored in a correction database.

FIG. 4 illustrates an example of correction values included in the parameter correction table.

FIG. 5 illustrates an example of how various gauge-like images are displayed in an instrument panel image.

FIG. 6 illustrates a condition under which an instrument panel displays an image for allowing a user to select a speedometer image.

FIG. 7(a) illustrates an example where the speedometer image is corrected, and illustrates an instrument panel image in which an uncorrected speedometer image is displayed.

FIG. 7(b) illustrates an example where the speedometer image is corrected, and illustrates an instrument panel image in which a corrected speedometer image is displayed.

FIG. 8 illustrates an example of areas that can be occupied by various gauge-like images displayed in an instrument panel image.

FIG. 9(a) illustrates an example where display states of various gauge-like images displayed in an instrument panel image are changed, and illustrates an example of a condition immediately after changing the instrument panel image.

FIG. 9(b) illustrates an example where display states of various gauge-like images displayed in an instrument panel image are changed, and illustrates areas that can be occupied by a navigator image and a speedometer image in the instrument panel image.

FIG. 9(c) illustrates an example where display states of various gauge-like images displayed in an instrument panel image are changed, and illustrates a condition under which a corrected navigator image and a corrected speedometer image are displayed in the instrument panel image.

FIG. 10(a) illustrates an example where a display state of the speedometer image is corrected, and illustrates a speedometer image whose display state has not been adjusted or corrected.

FIG. 10(b) illustrates an example where a display state of the speedometer image is corrected, and illustrates a speedometer image whose image size has been changed.

FIG. 10(c) illustrates an example where a display state of the speedometer image is corrected, and illustrates an instrument panel image having a speedometer image whose speed graduations are changed in terms of size.

FIG. 10(d) illustrates an example where a display state of the speedometer image is corrected, and illustrates an instrument panel image having a speedometer image whose speed graduations are changed in terms of size by a parameter correction section.

FIG. 11 is a block diagram for illustrating an arrangement of an instrument panel image changing system that includes a server having a storage section for storing at least either gauge-like image data or background image data and an instrument panel image display device which obtains at least either replacing gauge-like image data or replacing background image data from the server.

FIG. 12 is a flow chart illustrating operations in a background image changing mode.

FIG. 13 illustrates how to determine a standard color used to make monotone a background image.

FIG. 14 is a flowchart illustrating a process for changing a background image into a monotone image by using a multi-tone based on a color mainly used in the background image.

FIG. 15 is a flowchart illustrating a process for changing a background image into a monotone image by using a multi-tone based on one of the colors mainly used in the background image, where the combination of the color and the letter color of the gauge-like image is not a combination that has been forbidden in advance.

FIG. 16 is a flowchart illustrating a luminance correction process carried out with respect to the background image.

FIG. 17 is a flowchart illustrating a bordering process carried out with respect to the gauge-like image.

FIG. 18 illustrates an example of a color table which indicates a relationship between the letter color of the gauge-like image and a bordering color.

### DETAILED DESCRIPTION OF PREFERRED EMBODIMENTS

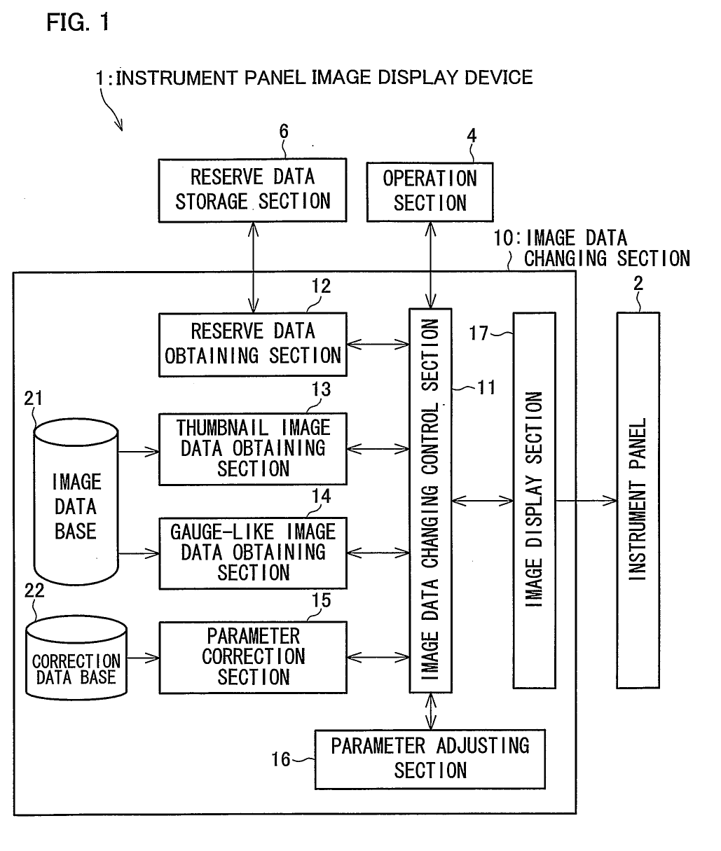

Preferred embodiments of the present invention are described below with reference to FIGS. 1-18.

FIG. 1 is a block diagram illustrating an arrangement of an instrument panel image display device 1 according to a preferred embodiment of the present invention. The instrument panel image display device 1 of FIG. 1 preferably includes an instrument panel 2, an operation section 4, a reserve data storage section 6, and an image data changing section 10.

The instrument panel 2 is a panel-type display that displays an instrument panel image generated by the instrument panel image data. For example, a liquid crystal panel can be used as the instrument panel 2, but the present invention is not limited to this.

The instrument panel image displayed in the instrument panel 2 includes a plurality of “gauge-like images,” categorized into various information such as a speedometer, a tachometer, an engine temperature gauge, a fuel gauge, various kinds of warning lights such as a seatbelt warning light, a shift indicator (indicative of a gear state), a warning indicator, a navigation window for showing a map, a Web window for indicating a Web site, a speed graph display, a speed value display, a turn signal, surrounding information of a vehicle (including information of the vehicle itself), and information of internal condition of the vehicle, for example. That is, knowledge of the above-described categories notifies a driver about various internal and external information of an apparatus. The instrument panel image provides information that is indispensable or beneficial in driving or entertaining the driver. Further, the instrument panel image displayed in the instrument panel 2 includes a “background image” which serves as a background of the gauge-like images. That is, the instrument panel 2 displays an instrument panel that includes the gauge-like images and the background image.

These various kinds of gauge-like images are displayed at specific positions of the instrument panel image, as desired. For example, as will be described later, a speedometer image displaying the running speed of the vehicle is preferably displayed in the instrument panel image to be positioned in front of the driver or on the side of the driver. That is, the speedometer image is positioned within a range that has been most appropriately determined in advance to be covered by the visual field of the driver. The instrument panel can be disposed in the center of a dashboard, depending on the type of the vehicle. Further, the position in which each gauge-like image is displayed is predetermined according to the category to which the gauge-like image belongs. However, as will be described later, it is possible to change the position.

It is not necessary that the instrument panel image displayed in the instrument panel 2 includes all of these gauge-like images. For example, the instrument panel image can include at least four kinds of the above-mentioned gauge-like images. However, for the sake of the security of the driver, the instrument panel image can include gauge-like images that indicate at least the speedometer, the turn signal, the fuel gauge, and the engine thermometer, for example.

Further, the instrument panel data that generates the instrument panel image displayed in the instrument panel 2 includes plural sets of gauge-like image data (image data) that respectively generate these gauge-like images. Further, it is not necessary that the instrument panel image data for generating the instrument panel image include all of the kinds of the aforementioned gauge-like images. That is, any data can be used as the instrument panel image data as long as the data generates the gauge-like image displayed in the instrument panel 2.

As will be described later, the instrument panel image display device 1 changes each of various gauge-like images included in the displayed instrument panel image into another image that belongs to the same category of that gauge-like image. For example, the instrument panel image display device 1 can change an analog-display-type speedometer into a digital-display-type speedometer.

This can be realized by changing the gauge-like image data, which generates the gauge-like image, into other gauge-like image data, which belongs to the same category of that gauge-like image data, (by carrying out the step of changing the image data) in the instrument panel image display device 1.

Further, the instrument panel image display device 1 allows the driver to change the display states of various gauge-like images. This can be realized, in the instrument panel image display device 1, by changing the parameter that defines the display state of each of the gauge-like images.

This parameter is included in each gauge-like image data. For example, the parameter preferably defines at least one of: (i) a size of the gauge-like image, (ii) a color of the gauge-like image, (iii) which part of the instrument panel image the gauge-like image is positioned in, (iv) the size of the font included in each gauge-like image, (v) the color of the font, and (vi) which part of the gauge-like image the font is positioned in, (vii) and other suitable definitions of the display state of the gauge-like image.

For example, the instrument panel image display device 1 can change the value indicative of the running speed of the vehicle, the size of the bar indicative of the running speed or the color of the bar, all of which are included in the analog-display-type speedometer, by changing the parameter which defines the display state of the speedometer image.

Detail descriptions thereof will be given below.

The operation section 4 is used by the driver and allows the instrument panel image display device 1 to be operated. The instrument panel image display device 1 changes at least one of the gauge-like image and the background image, which are displayed in the instrument panel 2, or changes the display state thereof, in accordance with various instructions inputted via the operation section 4. Further, it can be arranged that the operation section 4 includes an input device such as a mouse, a keyboard, a switch, a touch panel, or other suitable input device, and it can be arranged that instructions are inputted thereto in accordance with the image change interface that is displayed via an image data changing control section 11, the image display section 17, and the instrument panel 2.

The reserve data storage section 6 stores at least either reserve data of various gauge-like images (gauge-like image data) or reserve data of a background image (background image data). The gauge-like image data is indicative of a gauge-like image displayed in the instrument panel 2, and the background image data is indicative of a background image displayed in the instrument panel 2. Ordinarily, upon startup, the instrument panel image display device 1 uses the data stored in the reserve data storage section 6, which corresponds to at least either reserve gauge-like images or a reserve background image, thereby causing the instrument panel 2 to display an instrument panel image displayed at the time of ordinary operation.

The image data changing section 10 changes the gauge-like image displayed in the instrument panel 2 into another gauge-like image or changes the background image displayed in the instrument panel 2 into another background image, or carries out both changing operations. Further, the image data changing section 10 has a function for changing a display state of at least either the gauge-like image or the background image.

The present instrument panel image display device 1 allows the instrument panel image displayed in the instrument panel 2 to be more freely selected because the instrument panel image display device 1 includes the image data changing section 10. The following description describes an arrangement, an action, and an effect of the image data changing section 10. The instrument panel image display device 1 is installed on a vehicle.

As illustrated in FIG. 1, the image data changing section 10 includes an image data changing control section 11, a reserve data obtaining section 12, a thumbnail image data obtaining section 13, a gauge-like image data obtaining section 14, a parameter correction section (parameter judging means, parameter changing means) 15, a parameter adjusting section (parameter changing means) 16, an image display section (display means) 17, an image database 21, and a correction database 22.

The image data changing control section 11 controls the entire operation of the image data changing section 10. For example, the image data changing control section 11 receives a signal inputted from the operation section 4 and outputs the signal or data to various members of the image data changing section 10 described later.

The image data changing control section 11 includes a memory (not shown). The memory temporarily stores data of at least either various gauge-like images or the background image that have been obtained from the reserve data storage section 6 via the reserve data obtaining section 12 described later.

The reserve data obtaining section 12 accesses the reserve data storage section 6 and obtains data of at least either the reserve gauge-like images or the reserve background image. Further, the reserve data obtaining section 12 has a function for writing at least either the reserve gauge-like images or the reserve background image onto the reserve data storage section 6.

The thumbnail image data obtaining section 13 accesses the image database 21 and obtains the thumbnail image data. The thumbnail image data generates a thumbnail image indicating at least either the gauge-like image or the background image in small size. Further, as will be described later, the thumbnail image data is used by the image display section 17 in causing the instrument panel 2 to display an image that allows the driver to select at least either the replacing gauge-like image or the replacing background image.

The gauge-like image data obtaining section 14 accesses the image database 21 and obtains data of at least either the gauge-like image (gauge-like image data) or the background image (background image data). As described above, the gauge-like image data is data that generates each gauge-like image included in the instrument panel image. Further, as described above, the background image data is data that generates the background image included in the instrument panel image. The background image data can be generated by combining plural sets of data.

The gauge-like image data obtaining section 14 uses an identifier indicated by an identifier signal generated by the image data changing control section 11, thereby obtaining the gauge-like image data, which generates a gauge-like image selected by the driver, or obtaining the background image data, which generates a background image selected by the driver, or obtaining both the gauge-like image data and the background image data, from the image database 21. This will be discussed in detail below.

The parameter correction section 15 corrects the parameter that defines the display state of at least either the various gauge-like images or the background image. At this time, the parameter correction section 15 uses a parameter correction table for correcting at least the data of the gauge-like image or the data of the background image that are stored in the correction database 22. This table will be discussed in detail below.

Further, the parameter correction section 15 uses an identifier indicated by an identifier signal generated by the image data changing control section 11 from the correction database 22, thereby specifying and obtaining a correction parameter value applicable to at least either the gauge-like image data or the background image data targeted in the correction. This will be discussed in detail below.

The parameter adjusting section 16 changes the parameter, which defines a display state of at least either the gauge-like image or the background image, in accordance with the value inputted by the driver via the operation section 4.

The image display section 17 causes the instrument panel 2 to display the gauge-like image generated by the gauge-like image data and the background image generated by the background image data. Further, in order to schematically show the gauge-like image and the background image, the image display section 17 has a function for displaying a thumbnail image generated by thumbnail image data in the instrument panel 2.

The image database 21 is a database for storing the gauge-like image data that generates the gauge-like image, such as a speedometer, and for storing the background image data that generates the background image, with them respectively related to identifiers and the corresponding thumbnail images.

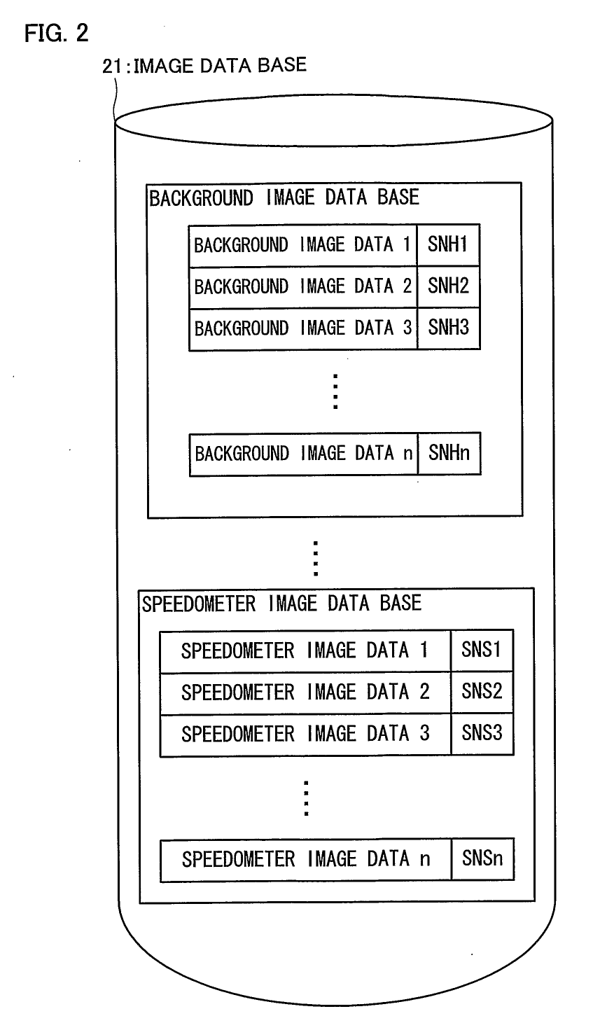

The image database 21 is illustrated in FIG. 2. FIG. 2 illustrates the gauge-like image data and the background image data that are stored in the image database 21. As illustrated in FIG. 2, the image database 21 stores, for example, a background database, or a sub-database (such as a speedometer image database) for storing sets of gauge-like image data that belong to the same category.

Each of these sub-databases stores each gauge-like image data, with its related identifier, and corresponding thumbnail image data. For example, as illustrated in FIG. 2, the background image database stores background image data 1 to n (n is a positive integer) with thumbnail image data SNH1 to SNHn, each of which generates a thumbnail image of each image. Further, although not shown, in the background image database, the gauge-like image data is related to an identifier corresponding to the image data.

Likewise, the speedometer database stores speedometer image data 1 to n with thumbnail image data SNS1 to SNSn, each of which generates a thumbnail image of each image. Also in the speedometer database, the stored gauge-like image data is related to an identifier corresponding to the image data.

In this manner, each of the thumbnail image data obtaining section 13 and the gauge-like image data obtaining section 14 uses an identifier, thereby specifying and obtaining the thumbnail image data, the gauge-like image data, and the background image data, that should be obtained from the image database 21. This will be discussed in detail below.

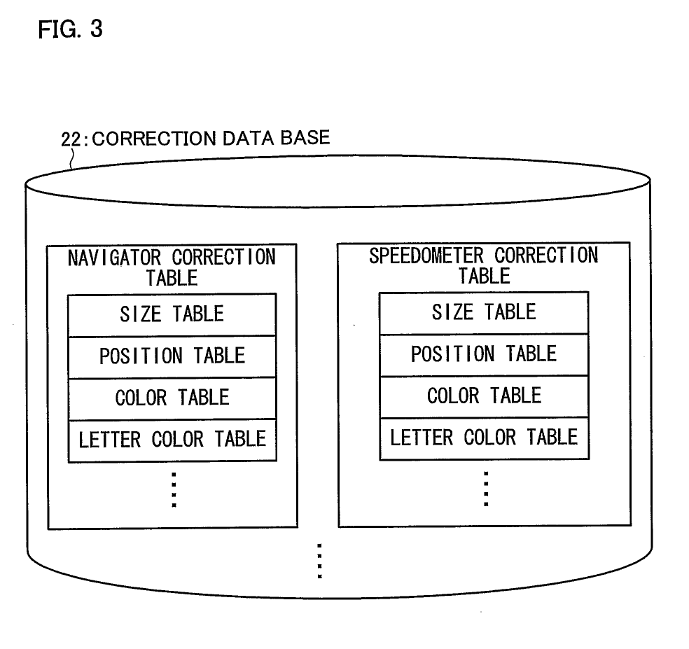

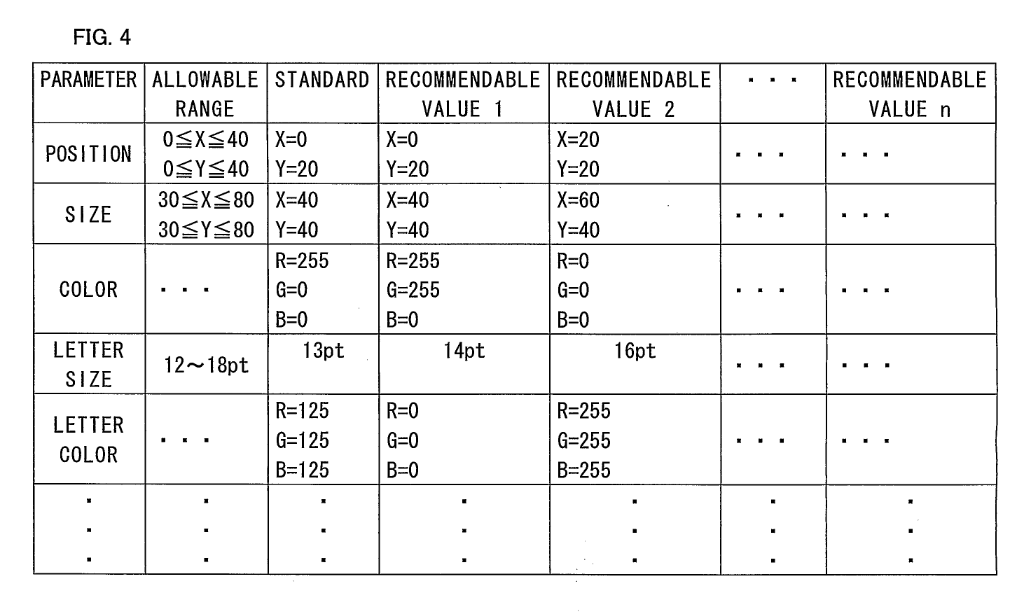

The correction database 22 is a database that is used to correct a parameter for defining the display state of at least either the gauge-like image or the background image and that stores a parameter correction table. The correction database 22 is discussed with reference to FIG. 3 and FIG. 4.

FIG. 3 illustrates the parameter correction table included in the correction database 22. As illustrated in FIG. 3, the correction database 22 stores, for example, a navigator correction table, or various kinds of parameter correction tables such as a speedometer correction table and other suitable correction tables. The particular kind of parameter correction table is not limited to the above-described parameter correction table, and the correction database 22 can include the parameter correction table corresponding to other gauge-like images and other background images that are displayed in the instrument panel 2.

Further, as illustrated in FIG. 3, the parameter correction table stores various kinds of sub-tables such as a position table, a color table, a letter color table, and other suitable tables. Each of these sub-tables stores correction values used to correct various kinds of parameters, each of which defines a display state of at least either the gauge-like image or the background image.

These sub-tables are described as follows with reference to FIG. 4. FIG. 4 illustrates an example of the parameter correction table included in the correction database 22.

As illustrated in FIG. 4, in the parameter correction table, there are sub-tables that respectively correspond to parameters for defining display states of gauge-like images, which include, for example, a position of each gauge-like image, a size of the gauge-like image, a color of the gauge-like image, a size of a letter included in the gauge-like image, and a letter color. As illustrated in FIG. 4, each of these sub-tables includes an allowable range within which a value of the parameter can increase or decrease, a standard value, and recommendable values 1 to n selected in correcting the parameter.

A specific example where the display state of the gauge-like image is corrected by using the correction database 22 will be described below.

The following description will describe how the instrument panel image display device 1 operates (gauge-like image changing mode). How the instrument panel image display device 1 changes the background image (background image changing mode) will be discussed in detail below.

First, at the time of an ordinary operation, an “image changing” button is displayed in the instrument panel 2. When the driver presses the button via the operation section 4, the instrument panel image display device 1 shifts its mode to the gauge-like image changing mode. Specifically, when the “image changing” button is pressed, the operation section 4 outputs a reserve data obtainment request signal to the image data changing control section 11.

When the reserve data obtainment request signal is inputted, the image data changing control section 11 outputs the signal to the reserve data obtaining section 12. As a result, the reserve data obtaining section 11 accesses the reserve data storage section 6, and obtains various stored kinds of gauge-like image data for display. Further, the reserve data obtaining section 12 outputs thus obtained gauge-like image data to the image data changing control section 11.

The image data changing control section 11, which has received the gauge-like image data, stores the data in a memory (not shown). Further, the image data changing control section 11 outputs a gauge-like image changing mode shift signal to the image display section 17. The image display section 17, which has received the signal, changes an image displayed in the instrument panel 2 into an image that allows a category of a replacing gauge-like image to be selected. For example, the image display section 17 displays a message such as “Select a category of a replacing image” in an upper position of the instrument panel 2.

Next, the driver selects an image, which belongs to a certain category, out of various gauge-like images displayed in the instrument panel 2. For example, the driver operates the operation section 4 to select one of the gauge-like images displayed in the instrument panel 2. When a mouse or other similar input device is used, one of the gauge-like images is “double-clicked.” As a result, the operation section 4 outputs a category identification signal, which is indicative of the category (a speedometer, a tachometer, and other suitable category) to which the replacing gauge-like image belongs, to the image data changing control section 11.

The image data changing control section 11, which has received the category identification signal, analyzes the signal and specifies the category to which the target gauge-like image belongs. In accordance with a result of the specifying operation, the image data changing control section 11 generates an identifier signal related to the thumbnail image data that generates a thumbnail image of the gauge-like image belonging to the category that has been selected by the driver. Further, the image data changing control section 11 outputs the generated identifier signal to the thumbnail image data obtaining section 13.

The thumbnail image data obtaining section 13, which has received the identifier signal, accesses the image database 21. Further, the thumbnail image data obtaining section 13 obtains the thumbnail image data from the image database 21 by using the identifier indicated by the identifier signal. The thumbnail image data obtained at this time generates a thumbnail image corresponding to the selectable gauge-like image in the driver-selected category to which the replacing gauge-like image belongs. The thumbnail image data obtaining section 13 outputs the obtained thumbnail image to the image data changing control section 11.

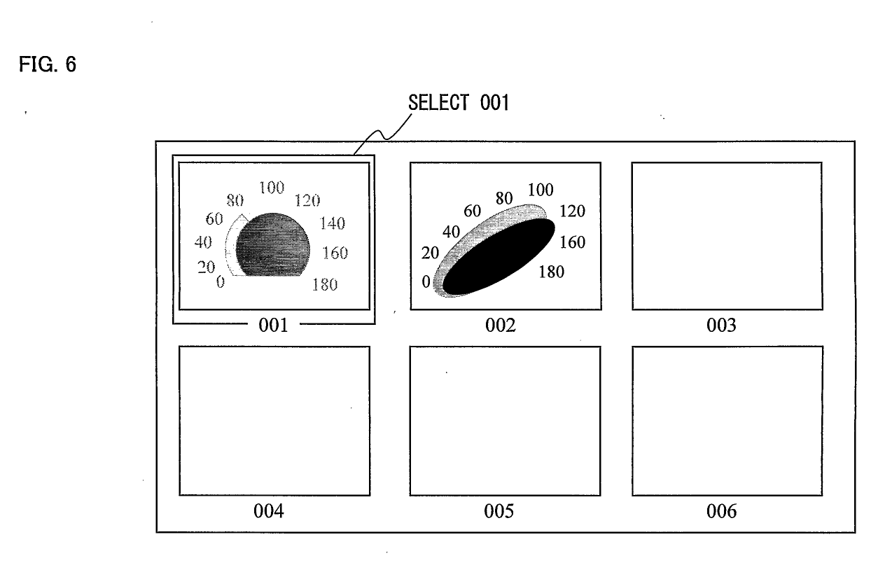

When the thumbnail image data is inputted, the image data changing control section 11 outputs the inputted data to the image display section 17. Further, the image display section 17 uses the inputted thumbnail data to display an image, which allows the driver to select a replacing gauge-like image, in the instrument panel 2. At this time, the instrument panel 2 displays the thumbnail image as illustrated in FIG. 6, for example.

Thereafter, the driver determines which image is to be displayed out of the various gauge-like images displayed in the instrument panel 2, which are indicated by thumbnail images. Specifically, for example, the driver “double-clicks” any one of the thumbnail images displayed in the instrument panel 2 via the operation section 4. Thus, the operation section 4 outputs an image identification signal, which indicates the kind of the replacing gauge-like image, to the image data changing control section 11.

When the image identification signal is inputted, the image data changing control section 11 analyzes the signal and specifies the replacing gauge-like image. In accordance with the result of the specifying operation, the image data changing control section 11 generates an identifier signal related to the gauge-like image data that generates the gauge-like image selected by the driver. Further, the image data changing control section 11 outputs the generated identifier signal to the gauge-like image data obtaining section 14.

When the identifier signal is inputted, the gauge-like image data obtaining section 14 accesses the image database 21. Further, the gauge-like image data obtaining section 14 obtains the gauge-like image data from the image database 21 by using the identifier indicated by the identifier signal. The gauge-like image data obtained at this time generates a replacing gauge-like image selected by the driver. The gauge-like image data obtaining section 14 outputs the obtained gauge-like image data to the image data changing control section 11.

When the gauge-like image data is inputted, the image data changing control section 11 outputs the data to the image display section 17. Further, the image display section 17 updates the image displayed in the instrument panel 2 by using the inputted gauge-like image data. Specifically, the image display section 17 replaces the original gauge-like image with another gauge-like image belonging to the same category as the original gauge-like image, which is generated by the inputted gauge-like image data to display the new gauge-like image (display step).

The foregoing process enables the gauge-like image displayed in the instrument panel 2 to be changed. At this time, the instrument panel 2 again displays an image, which allows the driver to select the category of the replacing gauge-like image. Thus, the driver can separately change gauge-like images belonging to various categories by selecting a gauge-like image belonging to a different category.

In other words, the instrument panel image display device 1 does not change image data, which generates the entire instrument panel image, into another instrument panel image, but changes image data, which generates each gauge-like image in the instrument panel image, into other image data, which generates other gauge-like images. That is, the instrument panel image selectable by the driver can be generated by combining gauge-like images generated by various gauge-like image data prepared in the image database 21. Thus, it is possible to select an instrument panel image having a new arrangement that has not been prepared in advance by combining changeable gauge-like images with each other. Thus, it is possible to more freely select an instrument panel image. For example, when there are eight categories of gauge-like images and when there are five gauge-like images which can be selected in each category, there are theoretically 1,953,125 patterns as instrument panel images that can be displayed in the instrument panel.

The present instrument panel image display device 1 can not only change a displayed gauge-like image into another image but can also adjust a display state of the gauge-like image. For example, the instrument panel image display device 1 can change a size, a color, and a position of each gauge-like image in the instrument panel image. This is described as follows.

First, the driver selects a gauge-like image for adjusting the display state via the operation section 4. For example, the driver selects one of gauge-like images displayed in the instrument panel 2 and presses an “adjustment” button. As a result, the operation section 4 outputs an adjusted image identification signal, which specifies a gauge-like image whose display state is to be changed, to the image data changing control section 11.

When the adjusted image identification signal is inputted, the image data changing control section 11 specifies gauge-like image data, which generates the gauge-like image whose parameter is to be adjusted, in accordance with the signal. Further, the image data changing control section 11 accesses a memory (not shown) and reads out the gauge-like image data whose parameter is to be adjusted. Further, the image data changing control section 11 specifies the kinds of display state parameters (size, color, position, and other suitable display state parameters) indicated by the various parameters for specifying a display state of the gauge-like image included in the gauge-like image data that has been read out. In accordance with the result of the specifying operation, the image data changing control section 11 outputs a signal, which is indicative of the kind of the specified parameter, to the image display section 17.

When the signal is inputted, the image display section 17 displays an image in the instrument panel 2 that allows the driver to input a parameter value which should be changed. The driver inputs a parameter value that defines a display state of the displayed gauge-like image via the operation section 17. For example, the driver inputs a vertical size and a horizontal size of the gauge-like image via the operation section 4. Further, the operation section 4, which has received the sizes, outputs the value inputted by the driver to the image data changing control section 11.

The image data changing control section 11, which has received the value, outputs the value and gauge-like image data, whose parameter is to be adjusted, to the parameter adjusting section 16. When the data and value are inputted, the parameter adjusting section 16 rewrites the parameter included in the gauge-like image data into the inputted value. Further, the parameter adjusting section 16 outputs the gauge-like image data, whose parameter has been rewritten, to the image data changing control section 11.

When the data is inputted, the image data changing control section 11 writes the inputted data into a memory (not shown). Further, the image data changing control section 11 outputs the data to the image display section 17. Further, the image display section 17 uses the gauge-like image data, whose parameter has been changed, to update the image displayed in the instrument panel 2. Thus, the instrument panel 2 displays a gauge-like image whose display state has been changed according to the value inputted by the driver.

Further, the aforementioned adjustment of the image display state is repeatedly carried out with respect to the respective gauge-like images in the instrument panel image so that the display states of the various gauge-like images displayed in the instrument panel 2 are respectively changed according to values inputted by the driver.

That is, the instrument panel image display device 1 can change a display state of the gauge-like images displayed in the instrument panel 2 by changing a value of a parameter, which defines a display state of the image indicated by the gauge-like image data, into another value (the value inputted by the driver). Thus, the instrument panel image display device 1 displays the gauge-like image, whose display state has been set by the driver, in the instrument panel 2. Thus, it is possible to much more freely select a displayed instrument panel image without decreasing the visibility.

When the adjustments of the display state of the gauge-like image are completed, the driver presses a “Finished” button displayed in the instrument panel 2 via the operation section 4. This causes the following correction of the display state of the gauge-like image to be carried out. First, the operation section 4 outputs an image changing completion signal to the image data changing control section 11.

When the signal is inputted, the image data changing control section 11 outputs all the gauge-like image data stored in the memory (not shown) to the parameter correction section 15. The parameter correction section 15, which has received the data, selects one of the data sets that have been inputted. Further, the parameter correction section 15 specifies an identifier, which corresponds to the gauge-like image generated by the gauge-like image data, in accordance with the selected data.

Next, the parameter correction section 15 accesses the correction database 22 and specifies a parameter correction table to be used in accordance with the specified identifier. Further, the parameter correction section 15 corrects the parameter, which is included in the gauge-like image data, with reference to the specified parameter correction table.

At this time, the parameter correction section 15 first confirms values of the various parameters stored in the gauge-like image data. Next, the parameter correction section 15 judges whether or not each of the values is within an allowable range, which is determined in the parameter correction table, within which a value of each parameter can increase or decrease. The judgment enables the instrument panel image display device 1 to previously detect that a gauge-like image whose display state is inappropriate to the driver (for example, a display state that decreases the visibility) is included in the instrument panel image.

Here, when the parameter correction section 15 judges that each of the values of the parameters included in the gauge-like image data is not within the allowable range, which is stored in the parameter correction table, within which a value of each parameter can increase or decrease, the parameter correction section 15 changes the parameter value into a value within the allowable range, which is stored in the parameter correction table, within which a value of each parameter can increase or decrease.

Due to this change, in the instrument panel image display device 1, the parameter value is set so that the parameter does not limitlessly have any value, but is limited within a predetermined range. Thus, in the instrument panel image display device 1, it is possible to appropriately display a gauge-like image so that the image whose display state is not inappropriate to the driver (for example, so that the visibility is not decreased). For example, when the allowable range within which a value of the parameter can increase or decrease is previously set to a value range that allows the driver to clearly recognize the gauge-like image, it is possible to change a hard to recognize gauge-like image into a display state that allows the driver to clearly recognize the gauge-like image.

The parameter correction section 15, for example, sets each of the various parameters to an arbitrary value of an allowable range within which a value of each parameter stored in the correction data can increase or decrease. However, it is preferable that the parameter correction section 15 changes the value into a value closest to a set value of the allowable range within which a value of the parameter can increase or decrease. For example, when a certain parameter is set to 100 and a value the parameter should be set to 50 to 70, it is preferable that the parameter correction section 15 sets the parameter to 70. Thus, it is possible to set the display state of the gauge-like image to be most similar to a display state adjusted by the driver.

Further, the parameter correction section 15, for example, can also change each of various parameters into a parameter value stored in the parameter correction table, which optimizes the display state. In this case, as illustrated in FIG. 4, the correction data includes the most appropriate recommendable values 1 to n that a certain parameter can be set to.

The parameter correction section 15 carries out the foregoing correction of the gauge-like image data with respect to all the inputted gauge-like image data. Further, when the correction is finished, the parameter correction section 15 outputs all the corrected data to the image data changing control section 11. When the gauge-like image data is inputted, the image data changing control section 11 temporarily stores the inputted data into a memory (not shown). Further, the image data changing control section 11 outputs the inputted data to the image display section 17.

When the data is inputted, the image display section 17 uses the gauge-like image data whose parameter has been corrected to update the instrument panel image displayed in the instrument panel 2. In this case, the image display section 17 causes the instrument panel 2 to display a message which requires the driver to confirm if the current display state is appropriate or not. At this time, for example, the instrument panel 2 displays an “OK” button and a “Next recommendable value” button.

When the driver presses the “Next recommendable value” button via the operation section 4, the operation section 4 outputs a next recommendable value selection signal to the image data changing control section 11. When the signal is inputted, the image data changing control section 11 outputs the inputted next recommendable value selection signal and the gauge-like image data stored in the memory (not shown) to the parameter correction section 15. Thus, the parameter correction section 15 accesses the correction database 22 and obtains the next recommendable parameter value (second recommendable value). Further, the parameter correction section 15 changes the value of the parameter included in the gauge-like image into the next recommendable value.

The parameter correction section 15 carries out the correction with respect to all the inputted gauge-like image data. When the correction is finished, the parameter correction section 15 outputs all the corrected gauge-like image data to the image data changing control section 11. When the corrected gauge-like image data is inputted, the image data changing control section 11 temporarily stores the inputted gauge-like image data into the memory (not shown) as described above. Further, the image data changing control section 11 outputs the inputted data to the image display section 17.

When the data is inputted, the image display section 17 uses the gauge-like image data whose parameter has been changed into the next recommendable value to update the instrument panel image displayed in the instrument panel 2. In this case, the image display section 17 causes the instrument panel 2 to display a message that requires the user to confirm if the current display state is appropriate or not. At this time, as described above, the instrument panel 2 displays an “OK” button and a “Next recommendable value” button.

Here, when the driver presses the “Next recommendable value” button, the aforementioned process causes the parameter included in the gauge-like image data to be rewritten into a further next recommendable value (third recommendable value) included in the correction data. It is possible to repeat this process until the last recommendable value (n-th recommendable value) included in the correction data is used.

However, when the driver presses the “OK” button via the operation section 4, the operation section 4 outputs an image changing completion signal to the image data changing control section 11. When the image changing completion signal is inputted, the image data changing control section 11 outputs the signal to the image display section 17. When the image changing completion signal is inputted, the image display section 17 causes the instrument panel 2 to display an instrument panel image at the time of a normal operation. The image data changing control section 11 outputs the gauge-like image data and a reserve data update signal to the reserve data obtaining section 12. When the data and the signal are inputted, the reserve data obtaining section 12 writes the inputted gauge-like image data into the reserve data storage section 6.

Because of the foregoing process, the instrument panel image displayed in the instrument panel 2 is updated into a new instrument panel image displayed with a new combination of gauge-like images that have been changed by the driver.

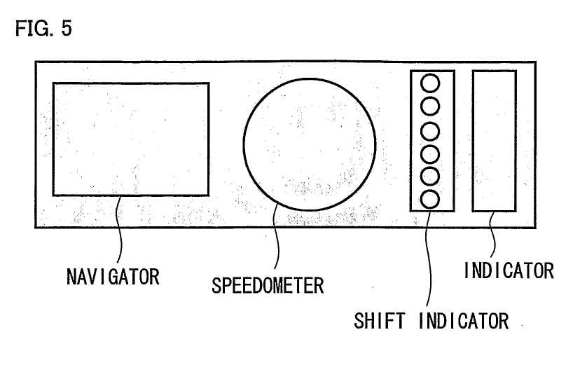

With reference to FIGS. 5 to 10, the following description will explain a specific example of the aforementioned processes in which the gauge-like image is changed.

FIG. 5 illustrates an example of various gauge-like images that can be displayed in the instrument panel image. In FIG. 5, the instrument panel image displayed in the instrument panel 2 is formed by combining gauge-like images, such as a navigator, a speedometer, and a shift indicator with a background image.

When the driver selects the change of the speedometer image via the operation section 4, as illustrated in FIG. 6, thumbnail images 001 to 006 that are stored in the image database 21, each of which indicates a different speedometer image, are displayed in the instrument panel 2. As illustrated in FIG. 6, the driver selects the thumbnail image 001.

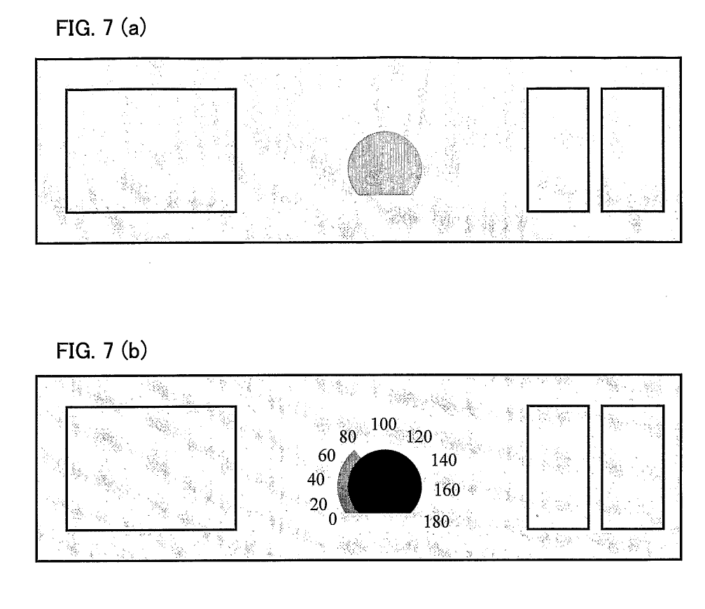

Then, as illustrated in FIG. 7(a), the speedometer image selected by the driver, i.e., the speedometer image corresponding to the thumbnail image 001, is displayed at a position where the speedometer image is supposed to be displayed in the instrument panel image of FIG. 5. However, a color of the speedometer image selected by the driver is extremely close to a color of the background image so that the speedometer image is not clearly displayed. Thus, this display state prevents the driver from recognizing the speed while driving the vehicle. This results in a higher possibility that an accident can occur.

Thus, in the instrument panel image display device 1, as described above, a function of the parameter correction section 15 causes the speedometer image displayed as illustrated in FIG. 7(a) to be corrected to display the speedometer image as illustrated in FIG. 7(b). FIG. 7(b) illustrates an instrument panel image in which the speedometer image corrected by the parameter correction section 15 is displayed. As illustrated in FIG. 7(b), the parameter correction section 15 uses the parameter correction table stored in the correction database 22 to correct the parameter that specifies the display state of the speedometer image. Before being corrected, speed graduations and the bar indicative of the vehicle speed are hard to recognize because they blend into the background image. However, in FIG. 7(b), the speed graduations and the bar can be clearly recognized. In this manner, the instrument panel image display device 1 corrects the gauge-like image data so that the speedometer is clearly recognized by the driver.

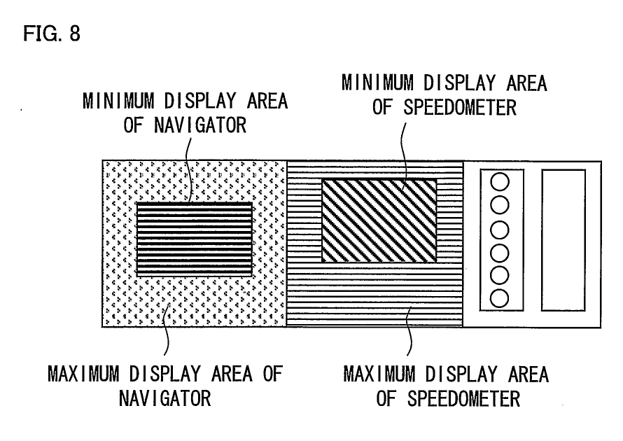

Further, the correction carried out by the parameter correction section 15 with respect to the gauge-like image data is effective in correcting the gauge-like image data adjusted by the parameter adjusting section 16. This is exemplified as follows with reference to FIGS. 8 to 10.

FIG. 8 illustrates an example of the areas that can be occupied by the gauge-like images displayed in the instrument panel image. As to the navigator image and the speedometer image, FIG. 8 illustrates the minimum display areas and the maximum display areas in which these images can be displayed. For example, these areas can be calculated in accordance with the parameter correction table stored in the correction database 22. That is, these areas can be calculated in accordance with the values included in the parameter correction table, each of which indicates an allowable size range and an allowable position range thereof.

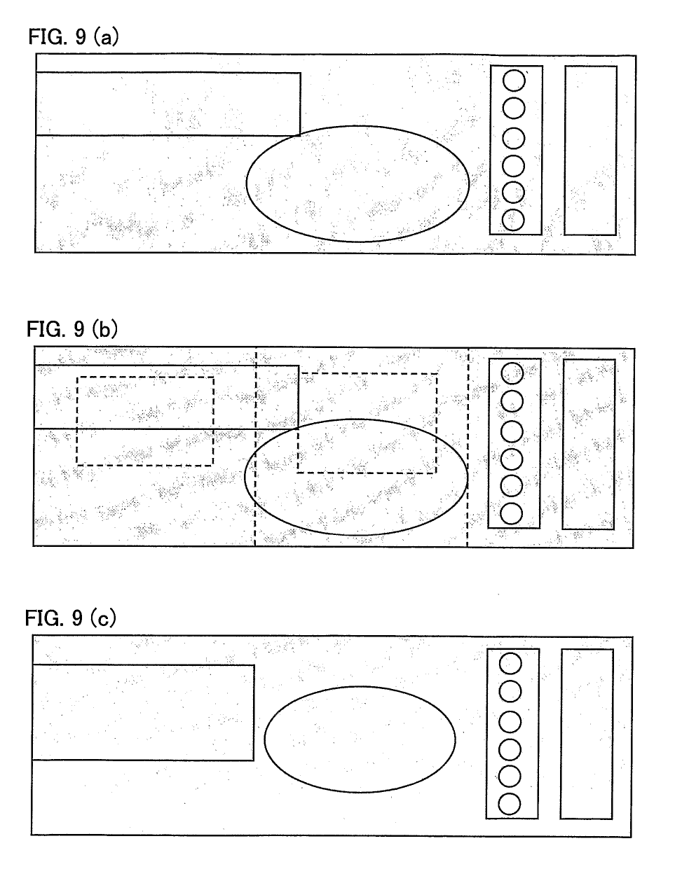

It is assumed that the driver changes the size and the position of the navigator image and the size and the position of the speedometer image via the operation section 4 and the parameter adjusting section 16, as illustrated in FIG. 9(a). When the sizes and the positions are changed, as illustrated by a broken line in FIG. 9(b), these adjusted gauge-like images extend over the maximum display areas.

Thus, the parameter correction section 15 corrects the parameter for defining each of the navigator image and the speedometer image so that the image is positioned within the maximum display area, as illustrated in FIG. 9(c). Thus, it is possible to prevent the gauge-like images from overlapping each other or prevent sizes thereof from being excessively reduced, which prevents the gauge-like images from being hard for the driver to recognize.

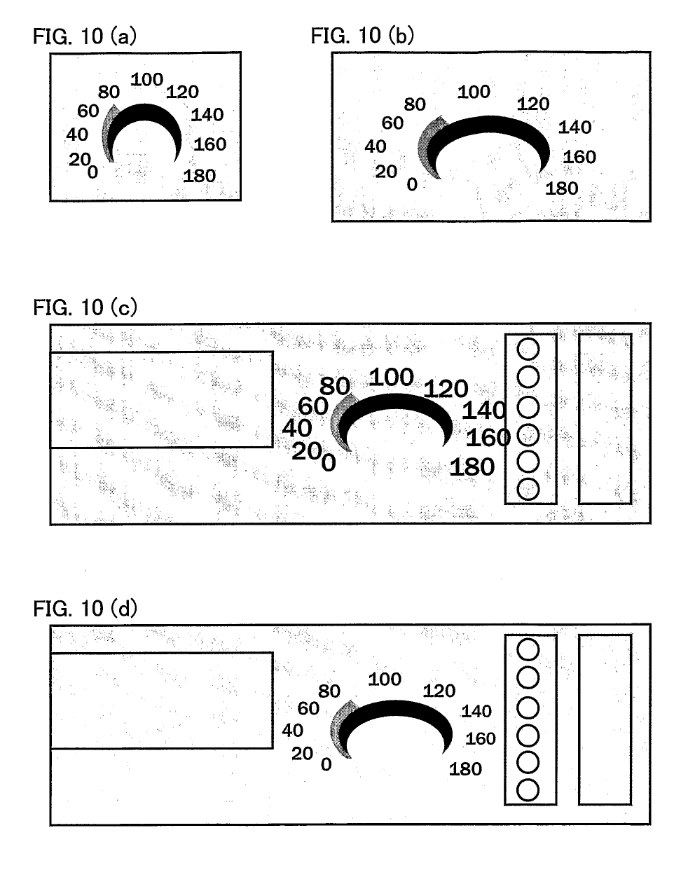

FIGS. 10(a)-10(d) illustrates another example where the speedometer image is corrected. FIG. 10(a) illustrates a speedometer image that the driver selects via the operation section 4. A display state of the image is neither adjusted by the parameter adjusting section 16 nor corrected by the parameter correction section 15. That is, the image is displayed according to a parameter in an initial state, or a default state.

When the driver adjusts the size of the image via the parameter adjusting section 16, an image illustrated in FIG. 10(b) is obtained. Note that, in the speedometer image, display states of the speed graduations and the other part (bar indicative of a current speed or a similar part) of the speedometer can be set separately from each other. The bar indicative of the current speed, or a similar part that are illustrated in FIG. 10(b), changes its size to correspond to the change in size of the entire image, but the size of each speed graduation does not change. A position where each speed graduation is displayed in the speedometer image changes according to the change in the size of the entire image.

In the image illustrated in FIG. 10(b), when the driver makes the size of the speed graduation larger and displays the enlarged speed graduation in the instrument panel image via the operation section 4 and the parameter adjusting section 16, an image illustrated in FIG. 10(c) is obtained. As illustrated in FIG. 10(c), the size of the speed graduation that has been set by the driver via the parameter adjusting section 16 is not balanced with the size of the speed bar. Thus, for the driver, the speed graduation and the speed bar seem not to be balanced with each other. Further, the speed graduation overlaps the shift indicator image so that these images are hard for the driver to recognize.

Thus, the parameter correction section 15 uses the correction database 22 in which correction values calculated in consideration of the foregoing points are stored in the parameter correction table, thereby correcting the parameter for defining the display state of the speedometer image. FIG. 10(d) illustrates an image obtained by changing the image of FIG. 10(c) based on the foregoing correction. As illustrated in FIG. 10(d), in the corrected speedometer image, the size of the speed graduation is adjusted to be balanced with the size of the speed bar so that the images are easy for the driver to recognize. Further, the speed graduation and the shift indicator do not overlap each other so that both the images are easy to recognize.

In the instrument panel image display device 1, it is preferable to correct the speedometer image, or other gauge-like image, in accordance with the display state of the speedometer image displayed in the instrument panel image. That is, in this instrument panel image display device 1, the parameter correction section 15 corrects the parameters for defining the display states of various gauge-like images so that the display state of the speedometer image is corrected into a display state which can be clearly recognized by the driver.

For example, the speedometer is a gauge for indicating the speed of the vehicle to the driver and is one of the most important gauges required for safely driving the vehicle. Thus, it is most preferable to display, in the instrument panel image, the speedometer image at a predetermined position within a range most appropriately determined in advance to be in front of the driver or to be included in the visual field of the driver. This enables the driver to confirm the speed of the vehicle with minimal movement of his/her visual line.

Thus, it is preferable that the correction database 22 stores a value for defining a region in which the corrected speedometer image is displayed in the instrument panel image to be positioned substantially in front of the driver. With this arrangement, even when the driver displays the speedometer image in an end portion of the instrument panel image, the parameter correction section 15 makes a correction so that the speedometer image is positioned near to the front of the driver. Thus, it is possible to prevent the speedometer image from being displayed so that its display state is hard for the driver to recognize or see clearly.

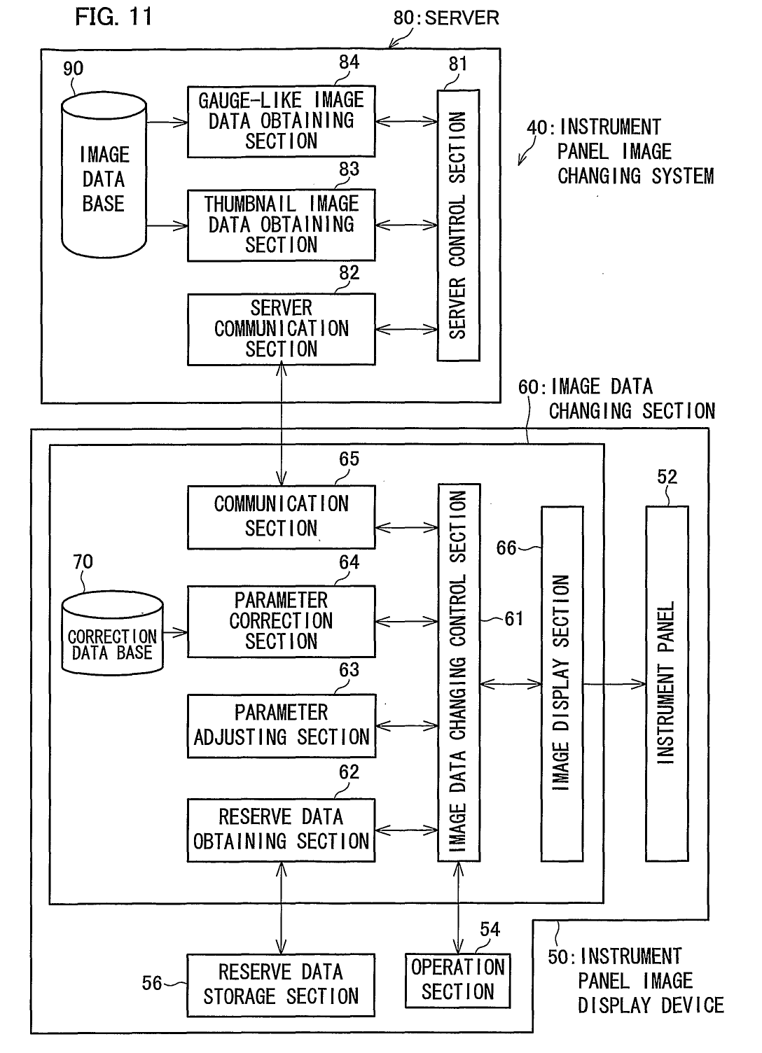

The instrument panel image display device of the preferred embodiments of the present invention can be arranged so that, as illustrated in FIG. 11, gauge-like image data that generates a replacing gauge-like image is obtained from a server, which has a storage section storing the gauge-like image data via a network line. In this case, the instrument panel image display device and the server define an instrument panel image changing system. The same arrangement is also adopted for the background image data.

The following description explains an instrument panel image changing system 40 illustrated in FIG. 11. FIG. 11 is a block diagram illustrating the detailed arrangement of the instrument panel image changing system 40 that includes a server 80 having a storage section storing the gauge-like image data and includes an instrument panel image display device 50 for obtaining the replacing gauge-like image data from the server 80. As illustrated in FIG. 11, the present instrument panel image changing system 40 includes the instrument panel image display device 50 and the server 80.

As illustrated in FIG. 11, the instrument panel image display device 50 includes an instrument panel 52, an operation section 54, a reserve data storage section 56, and an image data changing section (image data changing means) 60. The instrument panel 52, the operation section 54, and the reserve data storage section 56 are respectively arranged preferably in the same manner as the instrument panel 2, the operation section 4, and the reserve data storage section 6 discussed above. Thus, the description thereof will be omitted.

The instrument panel image display device 50 includes the image data changing section 60. Thus, the image data changing section 60 is described as follows with reference to FIG. 11.

As illustrated in FIG. 11, the image data changing section 60 includes an image data changing control section (image data changing control means) 61, a reserve data obtaining section 62, a parameter adjusting section (parameter adjusting means) 63, a parameter correction section (parameter changing means, parameter judging means) 64, a communication section (image data obtaining means) 65, an image display section (display means) 66, and an correction database 70. The reserve data obtaining section 62, the parameter adjusting section 63, the parameter correction section 64, the image display section 66, and the correction database 70 are respectively arranged preferably in the same manner as the reserve data obtaining section 12, the parameter adjusting section 16, the parameter correction section 15, and the correction database 22 discussed above. Thus, the description thereof will be omitted.

The communication section 65 sends a thumbnail image data request signal and a gauge-like image data request signal to a server communication section 82 provided on the server 80. These signals will be described later. Further, the communication section 65 has a function for receiving the thumbnail image data and the gauge-like image data that have been sent from the server communication section 82. That is, in the present instrument panel image display device 50, the communication section 65 has a function for obtaining the thumbnail image data and the gauge-like image data from the server 80 via a network line.

The image data changing control section 61 has, not only a function for controlling the entire operation of the image data changing section 60, but also a function for generating the thumbnail image data request signal and the gauge-like image data request signal that are sent from the communication section 82. This will be discussed in detail below.

The server 80, as illustrated in FIG. 11, has a server control section 81, a server communication section 82, a thumbnail image data obtaining section 83, a gauge-like image data obtaining section 84, and an image database 90.

The server control section 81 controls the entire operation of the server 80.

The server communication section 82 receives the thumbnail image data request signal and the gauge-like image data request signal that are sent from the communication section 65. Further, the server communication section 82 also has a function for sending the thumbnail image data and the gauge-like image data to the communication section 65.

The image database 90 is a database storing the gauge-like image data that generates various gauge-like images, such as the aforementioned speedometer image, with the related identifiers and corresponding thumbnail images. In this manner, the image database 90 is the same as the image database 21. However, unlike the image database 21, the image database 90 stores gauge-like image data corresponding to, not only a specific instrument panel image display device, but also various kinds of vehicles and various kinds of instrument panel image display devices.

That is, the image database 90 stores the gauge-like image data and the thumbnail image data, with the related identifiers, not only for respectively defining the data, but also for a vehicle identifier indicative of the kind of applicable vehicle and for a device identifier indicative of the kind of instrument panel image display device 50. Thus, the server 80, including the image database 90, can provide the gauge-like image data requested from various kinds of instrument panel image display devices 50 installed on various kinds of vehicles, according to each vehicle or each device which has requested the gauge-like image data.

The following description will describe the instrument panel image changing system 40.

In this system, the instrument panel image display device 50 operates preferably in the same manner as in the aforementioned instrument panel image display device 1 in terms of operations performed until the instrument panel 2 displays an image which allows the driver to input selection of a category of the replacing gauge-like image. When the image is displayed, the driver selects a category (for example, speedometer, tachometer, or other suitable category) to which the replacing gauge-like image belongs. Thus, the operation section 4 outputs a category identification signal, which is indicative of a category to which the replacing gauge-like image belongs, to the image data changing control section 61.

When the category identification signal is inputted, the image data changing control section 61 generates a thumbnail image data request signal obtained by adding to this signal (i) a device identification signal indicative of the kind of instrument panel image display device 50 and (ii) a vehicle identification signal indicative of the kind of vehicle having the instrument panel image display device 50. Further, the image data changing control section 61 outputs the thumbnail image data request signal to the communication section 65.

The communication section 65, which has received the thumbnail image data request signal, sends this signal to the server communication section 82. The server communication section 82 outputs the received thumbnail image data request signal to the server control section 81.

When the thumbnail image data request signal is inputted, the server control section 81 analyzes this signal and specifies (i) the category to which the target gauge-like image data belongs, (ii) the kind of instrument panel image display device used on the side of the vehicle, and (iii) the kind of vehicle having the instrument panel image display device. Further, in accordance with the result of the specifying operation, the server control section 81 generates the category identifier indicative of the category, the vehicle identifier indicative of a kind of the vehicle, and the device identifier indicative of a kind of the device. Thereafter, the server control section 81 generates the identifier signals indicative of the identifiers and outputs the generated identifier signals to the gauge-like image data obtaining section 84.

When the identifier signals are inputted, the gauge-like image data obtaining section 84 accesses the image database 90 and obtains thumbnail image data corresponding to the identifier indicated by each of the identifier signals. For example, the image database 90, first, determines a sub-database to access (various kinds of gauge-like image databases such as a speedometer database, which is the same as in the background database) in accordance with the category identifier. Next, the image database 90 accesses the determined sub-database and obtains all the thumbnail image data stored in the sub-database with the related device identifier and vehicle identifier, in accordance with the device identifier and the vehicle identifier. Further, the gauge-like image data obtaining section 84 outputs the obtained thumbnail image data to the server control section 81.

When the thumbnail image data is inputted, the server control section 81 outputs the inputted data to the server communication section 82. The server communication section 82 sends the inputted thumbnail image data to the communication section 65.

When the thumbnail image data is received, the communication section 65 outputs the received data to the image data changing control section 61. The image data changing control section 61 outputs the inputted data to the image display section 66. Thus, the image display section 66 causes the instrument panel 52 to display a thumbnail image generated by the thumbnail image data. Thereafter, the driver can select a selectable gauge-like image as a thumbnail image in the instrument panel 2 via the operation section 54.

The driver selects one of thumbnail images displayed in the instrument panel 2 via the operation section 54. Then, the operation section 54 outputs an image identification signal, which is indicative of the replacing gauge-like image, to the image data changing control section 61.

When the image identification signal is inputted, the image data changing control section 61 generates a gauge-like image data request signal, including the image identification signal, and outputs the generated signal to the communication section 65. The communication section 65 sends the gauge-like image data request signal to the server communication section 82.

When the server communication section 82 receives the gauge-like image data request signal, the server communication section 82 outputs the received signal to the server control section 81. Then, the server control section 81 analyzes the signal and generates an identifier signal, which is indicative of the identifier corresponding to gauge-like image data to be obtained, in accordance with the image identification signal included in the gauge-like image data request signal. Further, the server control section 81 outputs the image identifier signal to the gauge-like image data obtaining section 84.

When the identifier signal is inputted, the gauge-like image data obtaining section 84 accesses the image database 90 and obtains the single gauge-like image data related to the identifier indicated by the inputted identifier signal, in accordance with the identifier. Further, the gauge-like image data obtaining section 84 outputs the obtained gauge-like image data to the server control section 81.

When the gauge-like image data is inputted, the server control section 81 outputs the inputted data to the server communication section 82. Then, the server communication section 82 sends the inputted gauge-like image data to the communication section 65.

When the communication section 65 receives the gauge-like image data, the communication section 65 outputs the inputted data to the image data changing control section 61. Then, the image data changing control section 61 writes the inputted data into a memory (not shown) and outputs the data to the image display section 66.

Thus, the image display section 66 uses the inputted gauge-like image data to update the gauge-like image displayed in the instrument panel 52. Specifically, the image display section 66 replaces the gauge-like image, which has been displayed, with a gauge-like image, which is generated by the inputted gauge-like image data, thereby displaying the replacing gauge-like image. Thus, a new gauge-like image selected by the driver is displayed in the instrument panel 52 instead of an old gauge-like image.

The aforementioned instrument panel image changing system 40 is only an example, and the system can be arranged in other arrangements. For example, it can be arranged so that the correction database 70 is incorporated into the server 80.

In this case, the correction data obtaining section (not shown) for obtaining the correction data from the correction database 70 in the server 80 is provided on the server 80. Further, in the server 80, the correction data obtaining section obtains the correction data from the correction database 70 according to the correction data request signal sent from the communication section 65. Further, the server 80 sends the data to the instrument panel image display device 50 via the server communication section 82. Thus, the instrument panel image display device 50 uses the parameter correction data obtained from the server 80 so that the parameter correction section 64 corrects the parameter included in the gauge-like image data.

Alternatively, it can be arranged that the parameter correction section 64 is incorporated into the server 80. In this case, the parameter value, which defines the display state of a gauge-like image, and the identifier signal, which specifies the kind of gauge-like image whose display state is defined by the parameter, are sent to the server 80. Further, on the side of the server 80, the identifier indicated by the identifier signal is used to obtain the parameter correction data from the correction database 70, and thus the received parameter value is corrected. Further, the changed parameter value is sent to the instrument panel image display device 50.

In this case, in the instrument panel image display device 50, for example, the parameter adjusting section 63 uses the received parameter value to change the parameter value to be corrected. Also, this arrangement enables the parameter for defining the display state of the gauge-like image to be corrected.

Further, it can be arranged that the system sends uncorrected gauge-like image data to the server 80 instead of sending the parameter value. According to this system, the parameter is corrected in the server. Further, the server communication section 82 sends the gauge-like image data, whose parameter has been corrected, to the instrument panel image display device 50. In the instrument panel image display device 50, an image based on the corrected gauge-like image data is displayed without any modification.

In this manner, in the instrument panel image changing system 40, the instrument panel image display device 50 obtains the gauge-like image data from the server 80. Thus, even when the gauge-like image data that generates a new selectable gauge-like image is provided, it is possible to easily obtain the data. That is, even when data is updated on the side of the server or new data is added, it is possible to use the new data immediately.

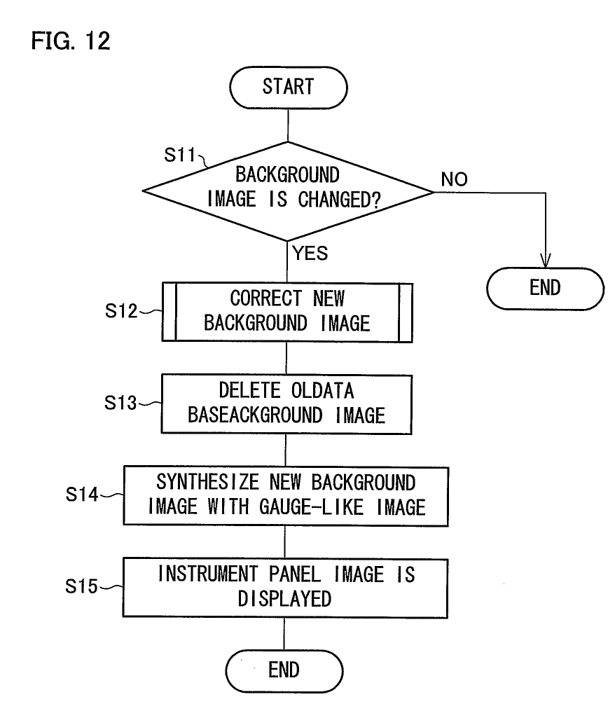

Next, with reference to FIGS. 12 to 18, the following description will describe how the instrument panel image display device 1 (FIG. 1) changes the background image (background image changing mode). Operations in the background image changing mode are basically the same as those in the aforementioned gauge-like image changing mode so that only differences therebetween will be explained.

FIG. 12 is a flowchart illustrating the operations in the background image changing mode.

In the background image changing mode, first, the image data changing control section 11 judges whether or not to change the background image (S11). Further, in case of changing the background image (YES in S11), the parameter correction section 15 corrects the parameter of the new background image data that the gauge-like image data obtaining section 14 has obtained by accessing the image database 21 (S12). The correction carried out by the parameter correction section 15 with respect to the parameter of the background image data will be discussed in detail below.

Thereafter, the image display section 17 deletes the old background image displayed in the instrument panel 2 (S13), the new background image, which is based on the background image data whose parameter has been corrected in S12, and the gauge-like image are synthesized with each other (S14), and the instrument panel image is displayed in the instrument panel 2 (S15).

In the case of displaying the background of the instrument panel image, an image which has not been made as the background of the instrument panel image (e.g., a photographic image taken by a user or a similar image), the number of colors, a hue, a brightness difference, and other suitable parameters of the image are not taken into consideration so that the visibility can decrease when the image is synthesized with the gauge-like images.

Thus, in the instrument panel image display device 1, the number of colors, a hue, a brightness difference, and other suitable parameters of the background image are automatically changed when changing at least the gauge-like image or the background image, and the changed background image is synthesized with the gauge-like image, thereby securing the visibility. Thus, it is possible to display as the background image of the instrument panel image an image desired by the user (for example, a photographic image) without decreasing the visibility of the gauges.

The process for changing the background image can be started at the following times: (i) When the user inputs an instruction to change the background image via the operation section 4; (ii) When the background image data is stored in a predetermined memory region; and (iii) When it is detected that the background image data stored in the reserve data storage section 6 is changed as an initial image displayed at the time of operation commencement. The predetermined memory region can be set in the image database 21 in advance. Further, in order to store the background image data into the predetermined memory region, it can be arranged that the user causes the data to be read from a storage medium, or it can be arranged that an external terminal or other suitable device carries out the storage via a network. When the change of the background image data is detected at the time of startup, the background image is changed at the time of the next startup after the background image data is changed.

Further, it can be arranged that, at the time of startup of the instrument panel image display device 1, first, a photograph image that is to serve as the background image is displayed on the entire screen and, then, the gauge-like images of the respective parts are displayed in the foreground.

The following description will describe how the parameter correction section 15 corrects the parameter of the background image (S12 of FIG. 12).

When a general photograph is used as the background image of the instrument panel image, there is no tendency in its color distribution so that it is difficult to ensure the visibility, as compared with an image originally made as the background image of the instrument panel image, even when the color and the size are changed. Therefore, in the instrument panel image display device 1, in case of using a general photograph as the background image of the instrument panel image, the following corrections of the parameter of the background image data are carried out in order to improve the visibility. The following corrections can be separately carried out or can be carried out in combination.

### (1) To Make Monotone the Background Image with a Standard Color Determined in Accordance with its Color Distribution

The image data changing section 10 changes the background image into a monotone image. Specifically, the image data changing section 10 calculates the color distribution of the background image, determines the color most used as a standard color, and uses a multi-tone (for example, approximately 16 grayscales) based on the standard color to change the background image into a monotone image.

When the color most used in the background image has a bad influence on the visibility of the gauges, the second most used color is used as the second recommendable standard color to change the background image into a monotone image. Further, when the second recommendable standard color has a bad influence on the visibility of the gauges, the third most used color can be used as a third recommendable standard color. That is, colors more used in the background image are more preferentially judged as the appropriate as the standard color. When all the recommendable colors are inappropriate as the standard color, a predetermined effective color (for example, white or black) can be used as the standard color. Further, how much the color is used in a single image can be judged in accordance with the number of pixels corresponding to each color.

In this manner, by using the color most used in the background image, it is possible to make monotone the background image without deteriorating the impression obtained by coloring the instrument panel. Further, by making the background image monotone in this manner, it is possible to avoid diffusive coloring of the background image. Thus, it is possible to most clearly distinguish the coloring of the gauge-like images, thereby improving the visibility. As long as the coloring of the background image is not diffusive, other colors can be mixed without strictly limiting the image to a monotone image.

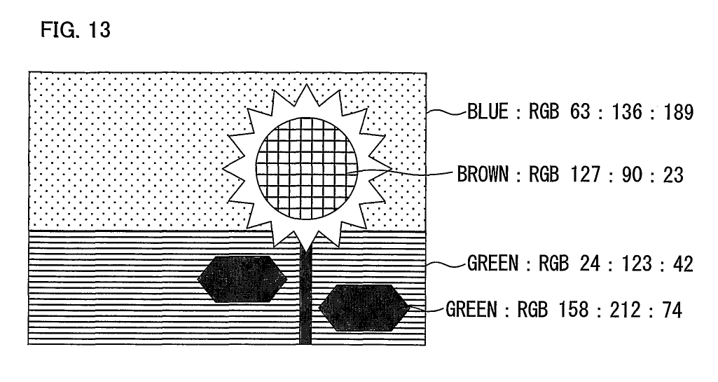

FIG. 13 illustrates how to determine the standard color. In FIG. 13, the most used color in the background is “blue (RGB 63:136:189)”, and the second most used color is “green (RGB 24:123:42)”. Further, in the foreground (corresponding to the gauge-like images), “brown (RGB 127:90:23)” and “green (RGB 158:212:74)” are used. Thus, in this example, “blue (RGB 63:136:189)” is adopted as the standard color for making monotone the background image, and “green (RGB 24:123:42)” is changed into a color in its multi-tone.

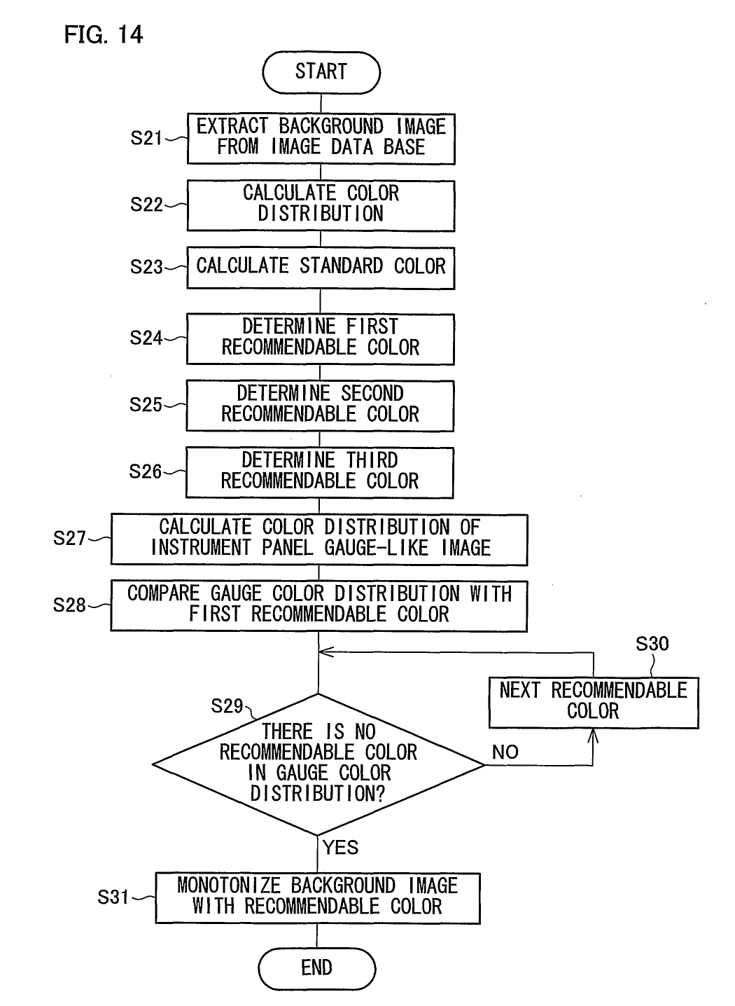

FIG. 14 is a flowchart illustrating a process for changing the background image into a monotone image by using a multi-tone based on the most used color in the background image.

First, the gauge-like image data obtaining section 14 extracts the background image data from the image database 21 (S21). Next, the image data changing control section 11 calculates the color distribution of the background (S22), and determines the most used color as a first recommendable color, the second most used color as a second recommendable color, and the third most used color as a third recommendable color (S23 to S26).

Next, the image data changing control section 11 calculates the color distribution of the gauge-like image (S27). Further, it is judged if the first recommendable color is included in the color distribution of the gauge-like image (S28, S29). When the first recommendable color is not included (YES in S29), the parameter correction section 15 makes monotone the background image by using the first recommendable color (S31). Further, when the first recommendable color is included in the color distribution of the gauge-like image (NO in S29), the next recommendable color is used to repeat the judgment (S30).

Likewise, it can be arranged that the image data changing section 10 calculates the color distribution of the currently displayed gauge-like image in changing the background image into a monotone image, uses a color which is not used in the gauge-like image or uses a color less used in the gauge-like image as the standard color, and uses a multi-tone (for example, approximately 16 grayscales) based on the standard color to change the background image into a monotone image.

In this manner, by making monotone the background image with a color that is not used in the gauge-like image, it is possible to avoid diffusive coloring of the background image. Thus, it is possible to most clearly distinguish the coloring of the gauge-like image, thereby improving the visibility.

### (2) To Make Monotone the Background Image with a Standard Color Determined on the Basis of Color Distribution of the Background Image and a Letter Color of the Gauge-Like Image

The image data changing section 10 calculates the color distribution of the background image in changing the background image into a monotone image and determines the more used colors as the standard color more preferentially. When a combination of each of the standard color and the letter color of the gauge-like image is not forbidden in advance, the image data changing section 10 uses a multi-tone (for example, approximately 16 grayscales) based on the standard color to change the background image into a monotone image. When all the recommendable standard colors are inappropriate, an effective color (for example, white or black) determined in advance can be used as the standard color. Further, how much the color is used can be determined, for example, in accordance with the number of pixels.

In this manner, by using a color mainly used in the background image, it is possible to make monotone the background image without deteriorating the impression obtained by coloring the instrument panel. Further, by making monotone the background image in this manner, it is possible to avoid diffusive coloring of the background image. Further, an inappropriate combination of the standard color and the letter color of the gauge-like image is forbidden in advance, thereby determining the standard color so that recognition of important letter information in the instrument panel image is not prevented. Thus, it is possible to most clearly distinguish the coloring of the gauge-like image, thereby improving the visibility. As long as the coloring of the background image is not diffusive, other colors can be mixed without strictly fixing the image to a monotone image.

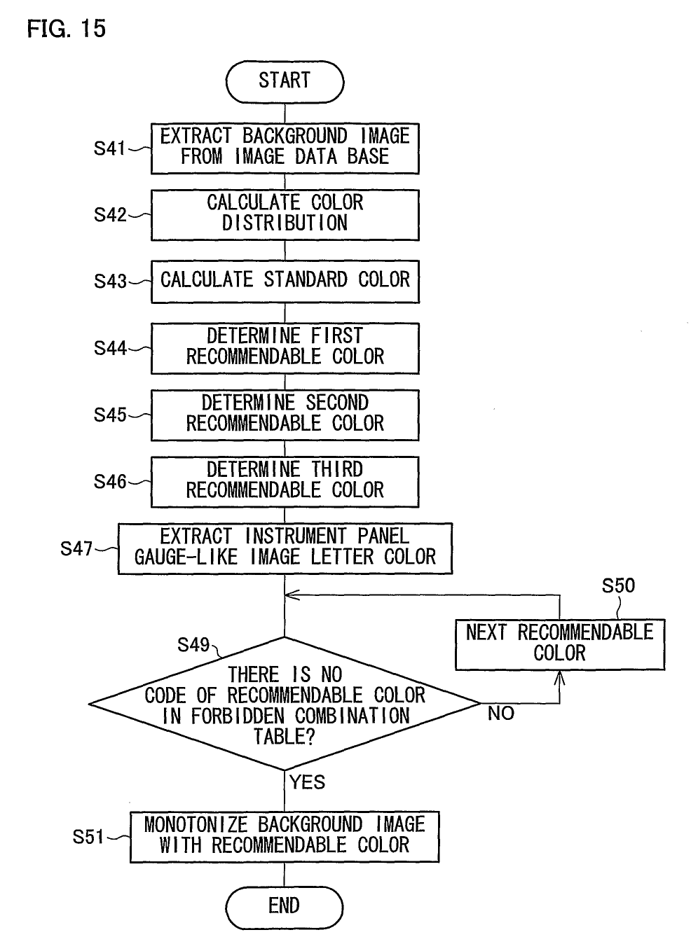

FIG. 15 is a flowchart illustrating a process for changing the background image into a monotone image by using a multi-tone based on one of the colors mainly used in the background image, where the combination of the color and a letter color of the gauge-like image is not forbidden in advance.

First, the gauge-like image data obtaining section 14 extracts the background image data from the image database 21 (S41). Next, the image data changing control section 11 calculates the color distribution of the background image (S42) and determines the most used color as a first recommendable color, the second most used color as a second recommendable color, and the third most used color as a third recommendable color (S43 to S46).

Next, the image data changing control section 11 extracts a letter color of the gauge-like image (S47). Further, it is judged if a combination of the letter color of the gauge-like image and the first recommendable color is a forbidden combination (S49). Specifically, it is judged if a generate of a recommendable color that cannot be used as the background image color is included in a combination forbidding table that is predefined for each letter color of the gauge-like image. The combination forbidding table can be stored in the correction database 22. Further, when the combination of the letter color of the gauge-like image and the first recommendable color is not forbidden (YES in S49), the parameter correction section 15 uses the first recommendable color to make monotone the background image (S51). Further, when the combination of the letter color of the gauge-like image and the first recommendable color is forbidden (NO in S49), the next recommendable color is used to repeat the judgment (S50).

### (3) To Correct Luminance of the Background Image

In the case of using a general photograph as the background image of the instrument panel image, the image varies in terms of its brightness, contrast, and other suitable parameters, depending on the of lighting and other conditions in the spot where the photograph was taken. Thus, the image data changing section 10 corrects the background image data to decrease the luminance of the background image so that average luminance of the background image is lower than average luminance of the gauge-like image by not less than a predetermined value. Thus, the gauge-like image is made brighter than the background image by not less than predetermined luminance, thereby improving the visibility.

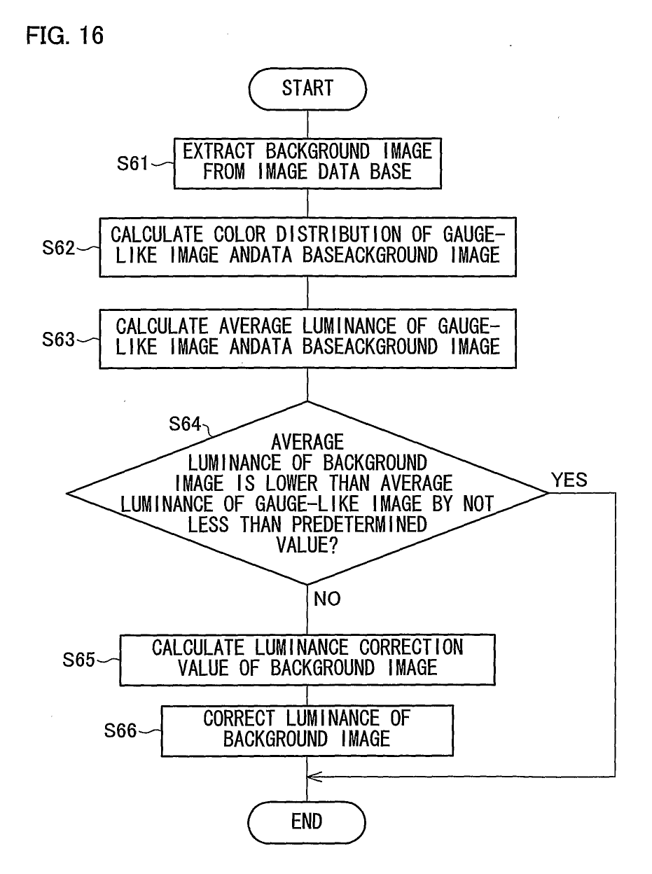

FIG. 16 is a flowchart illustrating a process for correcting luminance of the background image.

First, the gauge-like image data obtaining section 14 extracts the background image data from the image database 21 (S61). Next, the image data changing control section 11 calculates the color distribution of the gauge-like image and the background image (S62) and calculates average luminance thereof (S63).

Next, the image data changing control section 11 judges if the average luminance of the background image is lower than the average luminance of the gauge-like image by not less than a predetermined value (S64). Further, when the difference between the average luminance of the background image and the average luminance of the gauge-like image is smaller than the predetermined value (NO in S64), the image data changing control section 11 calculates a luminance correction value of the background image so that the average luminance of the background image is lower than the average luminance of the gauge-like image by not less than the predetermined value (S65), and the parameter correction section 15 uses the luminance correction value to correct the luminance of the background image (S66).

The luminance correction value can be constant, regardless of the luminance value to be corrected, or can be set according to the largeness of the luminance value. That is, the luminance correction value can be decreased at a constant value, regardless of the grayscale, or can be greatly decreased in case of low grayscale and can be slightly decreased in case of high grayscale.

Further, the luminance can be decreased by evenly decreasing RGB signals, or can be decreased by making the backlight dark. In the case of the latter, when the instrument panel 2 is provided with an LED backlight (white or RGB), the backlight can be made dark by controlling the backlight for every several dots.

The luminance is corrected in the foregoing description, but the contrast (chromaticity, brightness, and chromaticity) can also be corrected.

### (4) To Border the Gauge-Like Image

The image data changing section 10 marks the periphery of each gauge with a predetermined color so that the gauge is bordered. This improves the visibility of the gauge-like image. Thus, even in case of decreasing the luminance of the background image, the border of the gauge-like image enables the luminance correction value (correction amount) of the background image to be small. As a result, it is possible to use a background image more similar to the original image. Of course, it is possible to further improve the visibility when the gauge-like image is bordered after the luminance correction.

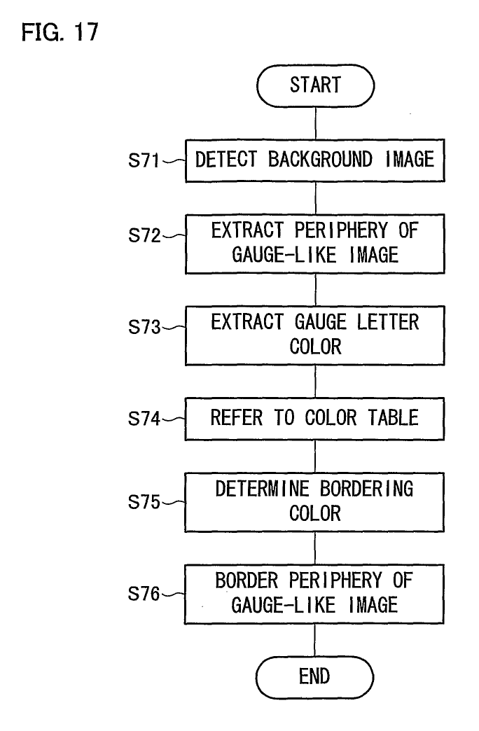

FIG. 17 is a flowchart for schematically illustrating a process for bordering the gauge-like image.

First, the gauge-like image data obtaining section 14 extracts the background image data from the image database 21 (S71). Next, the parameter correction section 15 extracts a peripheral portion of the background image (S72).

Next, the parameter correction section 15 extracts a color of a letter included in the gauge-like image (gauge letter color) (S73). Further, the parameter correction section 15 refers to a predetermined color table in accordance with the gauge letter color (S74) to determine a bordering color (S75). The color table is stored in the correction database 22 in advance.

Lastly, with the bordering color, the parameter correction section 15 marks the background image's portion surrounding the peripheral portion of the gauge-like image (S76).

The color table is a table which indicates RGB values of a color for bordering (bordering color) corresponding to RGB values of a letter color used in the gauge-like image (gauge letter color). In the color table, the number of gauge letter colors is predetermined. Thus, when a color different from the gauge letter color indicated by the table is used as a color of the gauge letter, RGB values of a bordering color corresponding to the gauge letter color RGB values that are closest to the color RGB values are used.

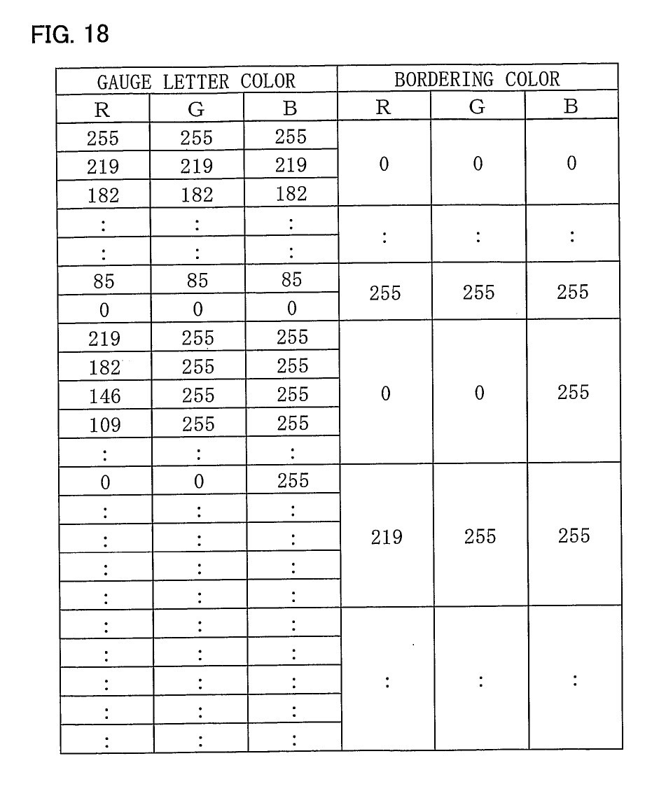

FIG. 18 is an example of the color table indicative of a relationship between the gauge letter color and the bordering color. In the example illustrated in FIG. 18, RGB values of 8 colors (multi-tone) and 254 colors (color) are defined as the gauge letter color, and the RGB values of the gauge letter color correspond to the RGB values of the bordering color.

According to the color table of FIG. 18, when the RGB values of the gauge letter color are 219, 219, 219 (light gray), a color indicated by 0, 0, 0 (black) is selected as the bordering color. Further, when the RGB values of the gauge letter color are 85, 85, 85 (dark gray), a color indicated by 255, 255, 255 (white) is selected as the bordering color. Further, when the RGB values of the gauge letter color are 219, 255, 255 (light blue), a color indicated by 0, 0, 255 (dark blue) is selected as the bordering color. Further, when this table does not have the RGB values of the gauge letter color, for example, when the RGB values are 218, 254, 254, a color indicated by 219, 225, 255 is selected as approximated RGB values so that the bordering color is 0, 0, 255.

The process for marking the periphery of each gauge with a predetermined color can be carried out with respect to the background image data as illustrated in the foregoing flowchart or can be carried out with respect to the gauge-like image data.

Further, the bordering color can be predetermined in the gauge-like image data as an outline color or can be calculated in accordance with the gauge letter color and the background image color.

### (5) To Inherit the Parameter of the Background Image

In the case of changing the background image, an unchanged original background image A is in a state (color distribution, brightness, contrast, and other similar parameters) suitable for display of the gauge-like image selected at this time, but a changed background image B is not always in the same state as in the original background image A. Thus, the image data changing section 10 carries out the image correction by changing a parameter of the new background image B so that a value indicative of the state of the new background image B is a value approximate to a value indicative of the state of the original background image A.

The image data changing section 10 enables the new background image B to be in the same state as in the original background image A by carrying out, for example, the following corrections with respect to the new background image B: (i) Color distribution of the original background image A is calculated, and a color of the new background image B is changed to have an approximate value of a color used in the color diffusion, thereby correcting the image; (ii) The brightness and the contrast of the original background image A are calculated, and the brightness and the contrast of the new background image B are changed to have approximate values of the brightness and the contrast of the original background image A, thereby correcting the image; and (iii) There is provided a table, which stores the predetermined values of the brightness and the contrast of the original background image A, in accordance with which values of the new background image B are corrected into the predetermined values.

Each of the instrument panel image display device 1 and the instrument panel image changing system 40 constitutes merely one preferred embodiment for carrying out the present invention. That is, as will be described below, the present invention can be varied within the scope of claims.

For example, any data format can be used as the data format of the aforementioned gauge-like image data, as long as the data format generates the image. That is, as the data format of the gauge-like image data and the background image data, it is possible to adopt a format in which an image such as BMP (Bitmap), or other similar formats, where data is stored at bit unit; a compressed data format such as TIFF (Tagged Image File Format) and JPEG (Joint Progressive Experts Group); or a vector data format such as EPS (Encapsulated PostScript) and PDF (Portable Document Format).

In the case of adopting the Bitmap format as the data format of the gauge-like image data and the background image data, plural sets of Bitmap data that indicate the gauge-like images and the background image, each of which varies in size, are prepared, and each of these images is changed to have a size set by the driver, thereby changing the display state without deteriorating a resolution of the image. By changing single Bitmap data, it is possible to display the gauge-like images and the background image, each of which varies in size.

Further, each of the gauge-like image data and the background image data can be data that generates a single still image or can be data that generates a moving image formed of a plurality of still images. Further, each of the gauge-like image data and the background image data can be a data group formed of plural sets of gauge-like image data and plural sets of background image data, each of which generates a single still image. For example, in the speedometer, with variation of the running speed of the vehicle, a state of the image displayed in the instrument panel is varied as time elapses. Thus, the gauge-like image data that generates the speedometer image is an image data group formed of plural sets of image data, each of which generates a still image indicating a state of the running speed.

Any format can be adopted as long as each of the image database 21 and image database 90 can store the gauge-like image data, the background image data, and the thumbnail image data. Further, any format can be adopted as long as each of the correction database 22 and the correction database 70 can store the correction parameter value and the identifier for specifying the kind of a parameter of the correction target with them related to each other. That is, with these databases, it is possible to adopt a hash-format database or a relational database in which the identifier and the data are stored with them related to each other.

Further, each of the correction database 22 and the correction database 70 stores a parameter correction table corresponding to each of the categories to which the various gauge-like image data and the background image data respectively belong. Because of this, it is possible to reduce the size of the database. However, the database can store a parameter correction table, which is indicative of each data that corresponds to each of the various gauge-like image data and each of the various background image data. In this case, it is possible to finely adjust a display state of at least either the gauge-like image or the background image, as compared with a format in which the parameter correction table corresponding to each category is stored.

Further, each of these databases is stored in an arbitrary nonvolatile storage medium (memory). Further, as to the storage medium, it does not matter if it is possible to rewrite (write) data therein, it does not matter how the storage is carried out, and it does not matter what shape the storage medium has. Examples of the storage medium include tapes, such as magnetic tape and cassette tape; disks, including magnetic disks, such as floppy disks (registered trademark) and hard disk, and optical disks, such as CD-ROMs, magnetic optical disks (MOs), mini disks (MDs), and digital video disks (DVDs); cards, such as IC card and optical cards; and semiconductor memories, such as mask ROMs, EPROMs, EEPROMs, and flash ROMs.

Further, in each of the correction database 22 and the correction database 70, the kind of the sub-table stored in the parameter correction table is not limited to the table illustrated in FIG. 4. That is, a sub-table for correcting other parameter can be included in the parameter correction table of each of the correction database 22 and the correction database 70. For example, the parameter correction table can include a sub-table that stores a correction value concerning luminance of each gauge-like image, a distance allowed between the gauge-like image and the other gauge-like image, or a distance allowed between letters included in the gauge-like image.

Further, when changing a recommendable value of the parameter to a next recommendable value, each of the parameter correction section 15 and the parameter correction section 64 can change, for example, a value of only the parameter designated by the driver to the next recommendable value instead of uniformly changing values of all parameters corresponding to all gauge-like images into the next recommendable values. Further, each of the parameter correction section 15 and the parameter correction section 64 can automatically correct the parameter, immediately after changing the parameter and without waiting for a correction instruction given by the driver via the operation section 4.

Further, in the instrument panel image display device 1, the instrument panel 2 (display panel) is a display panel for displaying an image based on the image data. The instrument panel 2 is a panel, long from side to side, whose aspect ratio indicative of a horizontal-vertical size ratio of its display area is not less than about 7:3. Thus, it is possible to improve the visibility when an additional image such as a navigation image and a vehicle state image indicative of a vehicle state, such as the speed and the fuel of the vehicle, are simultaneously displayed. Further, the aspect ratio can be set to, more specifically, 8:3, 30:9, 32:9, or a similar ratio, for example. Thus, the instrument panel 2 can be produced by combining two panels each of which has an aspect ratio of 4:3, 15:9, or 16:9. The instrument panel 2 of the present preferred embodiment is preferably a wide-size liquid crystal panel, but the instrument panel 2 is not limited to this. For example, an organic or inorganic EL (Electroluminescence) panel, a plasma display panel, a CRT (Cathode Ray Tube) can be used as the instrument panel 2. This is also true of the instrument panel 52.

Further, the image display section 17 can display a single instrument panel image including a plurality of gauge-like images in accordance with plural sets of image data generating the gauge-like images. Further, the image data changing section 10 can change at least one of the plural sets of image data generating gauge-like images into image data generating other gauge-like image.

As to the input operation performed via the operation section 4 and the operation section 54, it is possible to use, for example, a touch panel, hard keys, a mouse, or a joy stick. In the case of realizing the operation section 4 and the operation section 54 by using a touch panel, it is possible to respectively integrate the operation section 4 and the operation section 54 to the instrument panel 2 and the instrument panel 52.

Further, as to the correction performed by the driver with respect to the display state of the gauge-like image, it is possible to use, not only a method in which a value is directly inputted as a parameter value, but also a method in which the parameter value is changed into a value corresponding to a display state of an image after directly changing the display state in the screen. For example, in the case of changing the size of the image, it is possible to use a method in which a horizontal-direction size (X) and a vertical-direction size (Y) of the image are respectively inputted, a method in which an input operation is carried out by operating a slide bar, or a method in which a size of the image is changed in the screen by carrying out a “drag-and-drop” operation. Further, it can be arranged that an “enlarge” button and a “reduce” button are displayed in the image and that these buttons are pressed by the driver via the operation section 4 to change the size of the gauge-like image.

Further, it can be so arranged that a parameter for defining a display state of at least either the gauge-like image or the background image is stored, not in the gauge-like image data and the background image data, but collectively in another file. Further, it is preferable that the parameter defines at least the sizes and the colors of the gauge-like image and the background image. Thus, it is possible to change at least the sizes and the colors of the gauge-like image and the background image.

Further, when changing at least either the gauge-like image or the background image, it is possible to use a template file, which corresponds to each category of at least either the gauge-like image or the background image, in which a parameter for defining the display state has been set in advance. In this case, a display state of at least either the gauge-like image or the background image that has been selected by the driver is changed immediately after the selection performed in accordance with the parameter value stored in the template file so that it is possible to promptly finish the selection of at least either the gauge-like image or the background image.

Further, the foregoing description explains the case where the instrument panel image display device 1 is installed on the vehicle. Examples of the vehicle in the present specification include, not only an automobile, but also all land vehicles such as a motorbike, a bicycle, and other similar vehicles, each of which requires the driver to drive to move the vehicle. Further, the instrument panel image display device 1 is not limited to a device installed on the vehicle, but can be adopted to various transportation apparatuses such as a helicopter, a plane, a ship, and other similar vehicles, each of which requires the driver to drive to move. Further, the instrument panel image display device 1 is not limited to a device installed on the transport apparatus, but can also be adapted to a general apparatus provided with a control panel.

Further, any method can be adopted as a communication method between the communication section 65 and the server communication section 82, as long as the communication is carried out based upon wireless transmission. Examples of the wireless transmission include an infrared-ray communication used in IrDA and a remote controller; a communication which is in compliance with Bluetooth standard or IEEE802.11 standard; and a communication using HDR, a mobile phone network, or a ground wave digital network and other similar networks. Further, in these communications, transmission and reception of data and signals can be carried out with the data and the signals compressed.

Each of the aforementioned members is a function block. Thus, a computing apparatus, such as a CPU, can implement an instrument panel image display program stored in a storage section (not shown) and can control peripheral circuits such as an input/output circuit (not shown) and other suitable circuits, thereby defining the foregoing members.

Thus, a storage medium for computer-readably storing an instrument panel image display program generate (an executable program, intermediate generate program, or source program) of software for implementing the aforementioned functions is provided to the instrument panel image display device, and a computer (or CPU, MPU, and DSP) provided on the instrument panel image display device reads out the program generate stored in the storage medium to implement the program.

In this case, the program generate that has been read out from the storage medium performs the aforementioned functions, and the storage medium storing the program generate define other preferred embodiments of the present invention. Specifically, the image data changing section 10 provided on the instrument panel image display device 1 and the image data changing section 60 provided on the instrument panel image display device 50 include a predetermined program stored in a memory (not shown) of the instrument panel image display device and is implemented by a computing apparatus such as a microprocessor, for example.

Each of the aforementioned members can be realized as hardware for carrying out the same processes as performed by the software.

The computing apparatus adapted to read and implement the program generate functions by itself. Further, it can be arranged that a plurality of computing apparatuses connected to each other via a bus provided in the instrument panel image display device and various communication paths implement the program generate together.

The program generate, which can be directly implemented by the computing apparatus, is distributed to the instrument panel image display device via a computer-readable storage medium storing the program generate. Further, it can be arranged that the program generate is distributed to the instrument panel image display device as data, which can generate a program generate by carrying out a process such as uncompressing, via the computer-readable storage medium storing the data. Alternatively, it can be arranged that the program generate or the data is distributed or transmitted to the instrument panel image display device via a wired or wireless communication path. When the program generate is distributed or transmitted by any means, the program generate is implemented by the computing apparatus provided on the instrument panel image display device.

It is possible to transmit the program generate or the data via various kinds of communication networks without being limited to a specific network or specific method of transmission. Specific examples of the communication network include Internet, intranet, LAN, ISDN, VAN, a CATV communication network, a virtual private network, a telephone line network, a mobile communication network, a satellite communication network, and other suitable networks.

Further, a transmission medium (communication path) forming the communication network is not limited. Specifically, it is possible to use a wired line, such as a line in compliance with IEEE1394 standard, a USB line, a power line, a cable TV line, a telephone line, an ADSL line, and other similar lines, as the transmission medium. Further, it is possible to use (i) a wireless line utilizing an infrared ray used in IrDA and a remote controller, (ii) a wireless line which is in compliance with Bluetooth standard or IEEE802.11 wireless standard, and (iii) a wireless line utilizing HDR, a mobile phone network, a satellite line, a ground wave digital network, and other similar lines as the transmission medium.

It is preferable that the storage medium for distributing the program generate to the instrument panel image display device is detachable before distributing the program generate. However, the storage medium can be detachable after distributing the program generate, and the storage medium can be integrated to the instrument panel image display device so that the storage medium cannot be detached.

Further, as long as the storage medium stores the program generate, the storage medium can be rewritable (writable) or can be unwritable. Further, the storage medium can be volatile or can be nonvolatile. Further, any method for storing the program generate in the storage medium can be adopted, and any shape of the storage medium can be used.

Examples of the storage medium which satisfies these conditions include tapes, such as magnetic tape and cassette tape; disks including magnetic disks, such as floppy disks (registered trademark) and hard disk, and optical disks, such as CD-ROMs, magnetic optical disks (MOs), mini disks (MDs), and digital video disks (DVDs); cards, such as IC card (including memory cards) and optical cards; and semiconductor memories, such as mask ROMs, EPROMs, EEPROMs, and flash ROMs. A further example thereof is a memory formed in the computing apparatus, such as a CPU.

A program, which is for reading the program generate from the storage medium and storing the read program generate into a main memory, is stored in the instrument panel image display device in advance by a computer so that the program is executable. Further, in case of distributing the program generate to the instrument panel image display device via the communication network, a program for downloading the program generate from the communication network is stored in the instrument panel image display device in advance by a computer so that the program is executable.

Further, any program generate can be used as the program generate, as long as the program generate instructs the computing apparatus to carry out all the steps of the aforementioned processes. There are some computers that have a basic program (for example, an operating system or a library) that is executable by partially or entirely invoking each process based on the program generate in accordance with a predetermined procedure. In this case, as the program generate of the instrument panel image display device, it is possible to use a program generate all of whose procedures are partially or entirely replaced with one or more generates or one or more pointers for instructing the computing apparatus to invoke the basic program.

Further, in the storage medium, an instrument panel image display program is stored so that the program generate is stored in an actual memory. Specifically, the instrument panel image display program is stored so that the computing apparatus accesses the storage medium and executes the program generate. Alternatively, the instrument panel image display program can be stored in the storage medium under a condition before the program generate is stored in the actual memory whose medium (for example, hard disk) is always accessible by the computing apparatus. Alternatively, the instrument panel image display program can be stored in the storage medium under such condition that the program generate has not been installed from the communication network or a transportable storage medium to a local storage medium yet.

Further, the instrument panel image display program is not limited to the compiled object generate. For example, the instrument panel image display program can be stored in the storage medium as a source generate. Alternatively, the instrument panel image display program can be stored as an intermediate generate generated during interpretation or compilation.

In any of the foregoing cases, any program generate can be used as long as the program generate (intermediate generate) stored in the storage medium can be converted into a format executable by the computing apparatus.

That is, any program generate (intermediate generate) can be used as long as the program generate is converted into a format executable by the computing apparatus by the following operations: A predetermined format conversion program decompresses a compressed program generate, or restores a generated program generate, or interprets, compiles, links its source generate, or disposes the program generate in the actual memory, or executes the program generate by combining these processes. Because of this, it is possible to obtain the same effect regardless of the storage format in storing the instrument panel image display program in the storage medium.

The present invention is not limited to the preferred embodiments described above and can be varied within the scope of the present claims. That is, other embodiments obtained by combining various technical features, elements, steps and processes within the scope of the claims is included in the technical scope of the present invention.

Further, the instrument panel image display device according to various preferred embodiments of the present invention may further include a parameter changing section arranged to change a value indicated by a parameter which defines a display state of the gauge-like image into other value.

According to this arrangement, the present device can display a gauge-like image whose display state has been set by the user as he or she likes. Thus, it is possible to more freely select a displayed instrument panel image.

Further, the instrument panel image display device according to various preferred embodiments of the present invention may further include a parameter judging section arranged to judge if the value indicated by the parameter is within a predetermined range.

According to this arrangement, the present device can detect in advance that a gauge-like image whose display state is inappropriate for the user (for example, a display state that decreases the visibility) is included in the instrument panel image.

Further, the instrument panel image display device according to various preferred embodiments of the present invention is characterized in that, when the parameter judging section judges that the value indicated by the parameter is not within the predetermined range, the parameter changing section changes the value indicated by the parameter into a value within the predetermined range.

According to this arrangement, in the present device, a value of the set parameter is limited within the predetermined range without limitlessly having an arbitrary value. Thus, it is possible to change a gauge-like image whose display state is inappropriate for the user (for example, a display state that decreases the visibility) into a gauge-like image whose display state is appropriate. For example, when a value range of the parameter is set so that a display state of the gauge-like image can be clearly recognized, it is possible to change the gauge-like image which is hard to recognize into a gauge-like image which can be clearly recognized.

Further, the instrument panel image display device according to various preferred embodiments of the present invention is characterized in that the parameter preferably defines at least a size and a color of the gauge-like image.

According to this arrangement, the present device can change at least the size and the color of the gauge-like image.

Further, the instrument panel image display device according to various preferred embodiments of the present invention may further include an image data obtaining section arranged to obtain image data, which generates the other gauge-like image, via a network line from a server having a storage section that stores the image data.

According to this arrangement, even when the image data that generates a new selectable gauge-like image is provided, it is possible to easily obtain the data.

Further, the instrument panel image display device according to various other preferred embodiments of the present invention is characterized in that the apparatus is a vehicle, the instrument panel image includes at least a speedometer image indicative of the running speed of the vehicle as the gauge-like image, and the parameter changing section changes the parameter so that the speedometer image is preferably displayed in front of a driver or in a predetermined position in a visual field of the driver.

According to this arrangement, the speedometer image is displayed in front of the driver or in a predetermined position in a visual field of the driver (a position within a range that has been appropriately determined to be within a visual field of the driver, for example, a central position of a dashboard). Thus, the driver can confirm the running speed of the vehicle with minimum movement of his/her visual line.

Further, the instrument panel image display device according to various preferred embodiments of the present invention is characterized by further including parameter changing section arranged to change a value indicated by a parameter which defines a display state of the background image into another value.

According to this arrangement, the present device can display a background image whose display state has been changed so that the background image is not inappropriately displayed to the user (for example, a display state that decreases the visibility of the gauge-like image). Thus, it is possible to more freely select the displayed instrument panel image.

Specifically, as to a general photograph, there is no tendency in color distribution, and there is variation in brightness, contrast, and other suitable properties so that it is difficult to secure the visibility as compared with an image originally made as the background image of the instrument panel image, even when the color and the size are changed. Therefore, in the present device, in the case of using a general photograph as the background image of the instrument panel image, it is possible to secure the visibility by correcting the parameter of the background image. Thus, the user can freely select the background image.

Further, the instrument panel image display device according to various preferred embodiments of the present invention may further include a parameter judging section arranged to judge if the value indicated by the parameter is within a predetermined range.

According to this arrangement, the present device can detect in advance that a background image whose display state is inappropriate for the user (for example, a display state that decreases the visibility) is included in the instrument panel image.

Further, the instrument panel image display device according to various preferred embodiments of the present invention is characterized in that, when the parameter judging section judges that the value indicated by the parameter is not within the predetermined range, the parameter changing section changes the value indicated by the parameter into a value within the predetermined range.

According to this arrangement, in the present device, a value of the set parameter is limited within the predetermined range without limitlessly having an arbitrary value. Thus, it is possible to change a background image whose display state is inappropriate for the user (for example, a display state that decreases the visibility) into a background image whose display state is appropriate. For example, when a value range of the parameter is set so that a display state of the background image can be clearly recognized, it is possible to change the background image that is hard to recognize into a background image which can be clearly recognized.

Further, the instrument panel image display device according to various preferred embodiments of the present invention includes the parameter that defines at least either a color or luminance of the background image.

According to this arrangement, the present device can change at least either the color or the luminance of the background image. For example, it is possible to improve the visibility by changing the parameter of the background image data as follows:

(1) A color most used in the background image is used to make monotone the background image. This prevents the coloring of the background image from being diffusive. Thus, it is possible to most clearly distinguish the coloring of the gauge-like images, thereby improving the visibility;

(2) The background image is made monotone with a color that is not used in the gauge-like image. This prevents the coloring of the background image from being diffusive. Thus, it is possible to most clearly distinguish the coloring of the gauge-like images, thereby improving the visibility;

(3) An inappropriate combination of the standard color used to make monotone the background image and a letter color of the gauge-like image is forbidden in advance. Because of this, it is possible to determine the standard color so that recognition of important letter information in the instrument panel image is not prevented. Thus, it is possible to most clearly distinguish the coloring of the gauge-like images, thereby improving the visibility; and

(4) Correction is made to decrease the luminance of the background image so that the average luminance of the background image is lower than the average luminance of the gauge-like image by not less than a predetermined value. Because of this, it is possible to make the gauge-like image brighter than the background image by not less than predetermined luminance, thereby improving the visibility.

Further, the instrument panel image display device according to various preferred embodiments of the present invention includes the parameter changing section that changes a parameter of at least either the gauge-like image or the background image so that a periphery of the gauge-like image is bordered.

According to this arrangement, the present device can border a periphery of the gauge in the instrument panel image. Thus, the visibility of the gauge is improved. Further, even in the case of decreasing the luminance of the background image in order to improve the visibility of the gauge-like image, the border enables the luminance correction value of the background image to be reduced. As a result, it is possible to use a background image more similar to the original image.

Further, the present invention can be created as a server-client type system. In this case, an instrument panel image changing system preferably includes the instrument panel image display device and the server for providing image data, which generates the other gauge-like image, to the device.

A vehicle according to another preferred embodiment of the present invention is characterized by including the instrument panel image display device of other preferred embodiments of the present invention. According to this arrangement, it is possible to provide a vehicle including the instrument panel image display device that can more freely change the instrument panel image.

The instrument panel image display device may preferably include a computer. In this case, this preferred embodiment of the present invention includes an instrument panel image display program for causing a computer to realize the instrument panel image display device by causing the computer to operate as the foregoing elements and a computer-readable storage medium which stores the instrument panel image display program.

As described above, the instrument panel image display device of various preferred embodiments of the present invention changes each image data, which generates a gauge-like image included in the instrument panel image, into image data, which generates other gauge-like image, changes each image data, which generates a background image, into image data, which generates other background image, or carries out both operations so that it is possible to more freely select the instrument panel image with the visibility of gauges taken into consideration.

The present invention is applicable to an image display device installed on a transportation apparatus, such as an automobile provided with gauges, or a general apparatus, such as a control apparatus provided with a control panel, whose display image design can be changed.

It should be understood that the foregoing description is only illustrative of the present invention. Various alternatives and modifications can be devised by those skilled in the art without departing from the present invention. Accordingly, the present invention is intended to embrace all such alternatives, modifications, and variances that fall within the scope of the appended claims.

1-21. (canceled)

22. An instrument panel image display device, installed on an apparatus so as to display an instrument panel image, said instrument panel image display device comprising:
a display arranged to display the instrument panel image including a gauge image, by which internal and external information of the apparatus is provided to a user, in accordance with image data which generates the gauge image; and
an image data changing section arranged to change said image data, which generates the gauge image, into image data, which generates another gauge image.

23. The instrument panel image display device as set forth in claim 22, further comprising a parameter changing section arranged to change a value indicated by a parameter which defines a display state of the gauge image into another value.

24. The instrument panel image display device as set forth in claim 23, further comprising a parameter judging section arranged to judge whether the value indicated by the parameter is within a predetermined range or not.

25. The instrument panel image display device as set forth in claim 24, wherein, when the parameter judging section judges that the value indicated by the parameter is not within the predetermined range, the parameter changing section changes the value indicated by the parameter into a value within the predetermined range.

26. The instrument panel image display device as set forth in claim 25, wherein the parameter changing section changes the value indicated by the parameter into a value closest to a set value within the predetermined range.

27. The instrument panel image display device as set forth in claim 23, wherein the parameter defines at least a size and a color of the gauge image.

28. The instrument panel image display device as set forth in claim 22, further comprising an image data obtaining section arranged to obtain image data, which generates said another gauge image, via a network line, from a server having a storage section which stores the image data.

29. The instrument panel image display device as set forth in claim 23, wherein the apparatus is a vehicle, and the instrument panel image includes at least a speedometer image indicative of a running speed of the vehicle as the gauge image, and the parameter changing section changes the parameter so that the speedometer image is displayed in front of a driver or in a predetermined position in a visual field of the driver.

30. An instrument panel image display device, installed on an apparatus so as to display an instrument panel image, said instrument panel image display device comprising:
a display arranged to display the instrument panel image including a gauge image, by which internal and external information is provided to a user, and a background image, which serves as a background of the gauge image, in accordance with image data that generates said gauge image and image data that generates the background image; and
an image data changing section arranged to change said image data, which generates the background image, into image data, which generates another background image.

31. The instrument panel image display device as set forth in claim 30, further comprising a parameter changing section arranged to change a value indicated by a parameter that defines a display state of the background image into another value.

32. The instrument panel image display device as set forth in claim 31, further comprising a parameter judging section arranged to judge whether the value indicated by the parameter is within a predetermined range or not.

33. The instrument panel image display device as set forth in claim 32, wherein, when the parameter judging section judges that the value indicated by the parameter is not within the predetermined range, the parameter changing section changes the value indicated by the parameter into a value within the predetermined range.

34. The instrument panel image display device as set forth in claim 31, wherein the parameter defines at least one of a color or a luminance of the background image.

35. The instrument panel image display device as set forth in claim 31, wherein the parameter changing section changes a parameter of at least either the gauge image or the background image so that a periphery of the gauge image is bordered.

36. A server, providing the image data that generates said another gauge image to the instrument panel image display device as set forth in claim 28.

37. An instrument panel image changing system, comprising the instrument panel image display device as set forth in claim 28 and a server for providing the image data that generates said another gauge image to the instrument panel image display device.

38. A vehicle, comprising the instrument panel image display device as set forth in claim 22.

39. A method of changing an instrument panel image displayed in an instrument panel image display device installed on an apparatus, said method comprising the steps of:
displaying the instrument panel image including a gauge image, by which internal and external information of the apparatus is provided to a user, in accordance with image data which generates the gauge image; and
changing the image data, which generates said gauge image, into image data that generates another gauge image.

40. A method of changing an instrument panel image displayed in an instrument panel image display device installed on an apparatus, said method comprising the steps of:
displaying the instrument panel image including a gauge image, by which internal and external information of the apparatus is provided to a user, and a background image, which serves as a background of the gauge image, in accordance with image data that generates the gauge image and image data that generates the background image; and
changing the image data, which generates said background image, into image data, which generates another background image.

41. An instrument panel image display program, causing the instrument panel image display device as set forth in claim 22 to operate, said instrument panel image display program being characterized by causing a computer to perform the following steps:
displaying the instrument panel image including a gauge image, by which internal and external information of the apparatus is provided to a user, in accordance with image data which generates said gauge image; and
changing the image data, which generates said gauge image, into image data, which generates another gauge image.

42. A computer-readable storage medium, storing the instrument panel image display program as set forth in claim 41.
